(19) United States
(12) Patent Application Publication
(10) Pub. No.: US 2025/0155463 A1
(43) Pub. Date: May 15, 2025

(54) DUAL-HEAD MAGNETIC LIQUID HANDLER ROBOT FOR HIGH THROUGHPUT ANTIBODY PURIFICATION APPARATUS, SYSTEM AND METHOD

(71) Applicant: Dynamic Devices LLC, Wilmington, DE (US)

(72) Inventors: Jean-Marc Haab, Wilmington, DE (US); Kelly Kreitlow, Wilmington, DE (US)

(73) Assignee: Dynamic Devices LLC, Wilmington, DE (US)

(21) Appl. No.: 18/949,983

(22) Filed: Nov. 15, 2024

Related U.S. Application Data
(60) Provisional application No. 63/598,950, filed on Nov. 15, 2023.
(60) Provisional application No. 63/548,554, filed on Nov. 15, 2023.

(51) Int. Cl. G01N 35/10; B01L 3/00; G01N 35/00

(52) U.S. Cl. CPC G01N 35/1009; B01L 3/5085; G01N 35/0099; G01N 35/1074; B01L 2300/0829; G01N 2035/1076

(57) ABSTRACT

An apparatus, system, process, and method for purifying, handling and otherwise processing engineered biologics molecules which may comprise plate-based antibody purification processes is disclosed. The resultant purified molecules may be further processed optimized, and/or used in other manufacturing processes and/or manufactured products. In one embodiment the system and method employed for the processing and purifying of antibodies comprises a high speed, high throughput, dual-head magnetic liquid handler robot and related systems which efficiently produces end product at high yields. In certain embodiments, the system is fully automated providing for cost-effective and efficient means for purifying, handling and otherwise processing engineered biologics molecules such as the purification of plate-based antibodies in commercially advantageous quantities. The resultant purified molecules may be further processed optimized, and/or used in other manufacturing processes and/or manufactured products. Also disclosed is an embodiment of the invention which utilizes a magnetic liquid handler robot and related systems comprising a single robotic arm which automatically interchanges tooling heads and which efficiently produces end product at high yields.

### CROSS REFERENCE TO RELATED APPLICATIONS

This application claims priority to and the benefit of U.S. Provisional Patent Application Ser. No. 63/598,950, entitled “DUAL-HEAD MAGNETIC LIQUID HANDLER ROBOT FOR HIGH THROUGHPUT ANTIBODY PURIFICATION APPARATUS, SYSTEM AND METHOD” filed Nov. 15, 2023, the entirety of which is incorporated herein by reference.

This application also claims priority to and the benefit of U.S. Provisional Patent Application Ser. No. 63/548,554, entitled “DUAL-HEAD MAGNETIC LIQUID HANDLER ROBOT FOR HIGH THROUGHPUT ANTIBODY PURIFICATION APPARATUS, SYSTEM AND METHOD” filed Nov. 15, 2023, the entirety of which is incorporated herein by reference.

### FIELD OF THE DISCLOSURE

The present embodiments are generally directed to apparatuses, systems and methods for purifying, handling and otherwise processing engineered biologics molecules which may comprise plate-based antibody purification processes. The resultant purified molecules may be further processed optimized, and/or used in other manufacturing processes and/or manufactured products.

### BACKGROUND

The reliable, efficient and cost-effective purification of plate-based antibodies in commercially acceptable quantities and at commercially acceptable speeds has long been challenging from the manufacturing perspective. Prior apparatuses, systems and methods employed in plate-based purification processes utilized bench/laboratory style equipment originally engineered for purifying small quantities of DNA using plate formats at low volumes and throughput (see e.g. ThermoFisher Scientific Inc.'s KingFisher magnetic particle separator and Tecan Phynexus Phytip Robot purification instruments). Devices such as these were originally engineered for purifying small quantities of DNA using plate formats and sometimes would be adopted for purifying antibodies. As such, these existing systems do not allow for the reliable, efficient, automated, high-speed purification and processing of plate-based antibodies.

Current systems and methods of purification are unable to provide enough protein in single cycles to meet the needs of scientists who are screening therapeutic antibodies. In addition, the cycle times for antibody purification which utilize current systems and methods are far too long at between about one to about one- and one-half hours in length. In addition, such systems are not fully automated and may only be able to purify antibodies only from clarified cell cultures and/or elute in a diluted form. Still other systems and methods only purify proteins in 96-format titer plates and not in 24-format plates, or do not purify proteins at larger scales beyond 24 and 96 format plates.

Accordingly, there exists a need for reliable, efficient, high speed, high throughput, fully automated, cost-effective apparatuses, systems and methods for purifying, handling and otherwise processing engineered biologics molecules such as the purification of plate-based antibodies in commercially acceptable quantities and wherein the resultant purified molecules may be further processed optimized, and/or used in other manufacturing processes and/or manufactured products.

### SUMMARY OF THE DISCLOSURE

The present disclosure relates to apparatus, systems, processes, and methods for the high throughput purification, handling and processing of high-quality engineered biologics molecules which may comprise plate-based antibody purification processes. The resultant purified molecules may be further processed optimized, and/or used in other manufacturing processes and/or manufactured products.

In certain embodiments the apparatus, systems, processes and methods of the invention purify large panels consisting of hundreds to thousands of engineered biologics molecules in high throughput fashion for screening out those with poor therapeutic and manufacturability attributes. The selected molecules are passed on to process development for scale-up optimization before passing the selected molecules on to manufacturing.

In certain embodiments, the disclosure relates to apparatus, systems, processes, and methods for producing purified antibodies which comprise one or more of the following: a dual-head magnetic liquid handler capable of accommodating high volume, large array, strongly magnetized plates for securing and transporting pipettes through the purification process; a dual-head magnetic liquid handler comprising strong magnetization of plates for magnetic bead capture and efficient removal of impurities from the antibodies without bead loss during purification; processing in greatly shorted cycle times such as, for example, the ability to purify antibodies in 96-format in cycle times between about five minutes and about eight minutes; the ability to purify antibodies in yields between them about 10 and about 20 times higher than existing systems; a fully automated system; a cascade, positive pressure plate filtration system for aggregate clearance from each individual pipette comprising a pressure sensitive feedback system allowing each individual pipette to be fully cleared independent of the clearance of any other pipette held on the plate; a positive pressure manifold for antibody dilution in high concentration; a system having an integrated liquid handler and positive pressure manifold in one system; and/or a dual-head liquid handler system for expediting liquid delivery into and removal of washes from plate wells.

### BRIEF DESCRIPTION OF THE DRAWINGS

The accompanying drawings, diagrams, figures and/or Appendices, which are included to provide a further understanding of the invention and are incorporated in and constitute a part of this specification, illustrate embodiments of the invention and together with the description serve to explain the principles of the disclosure, in which like numerals refer to like components or steps, and wherein:

FIG. 1 is a block flow diagram of a workflow overview of one embodiment of the disclosure.

FIG. 2 is a block flow diagram of the workflow of one embodiment of the disclosure comprising a dual-head magnetic liquid handler system enabling high throughput antibody purification, and further including nine sheets comprising enlarged sections of FIG. 2, each of said nine sheets collectively comprising the entire contents of FIG. 2.

FIG. 3 is a rear view of one embodiment of the bead wash tool of one embodiment of the invention.

FIG. 4 is a bottom view of one embodiment of the bead wash tool of one embodiment of the invention.

FIG. 5 is a side view of one embodiment of the bead wash tool of one embodiment of the invention.

FIG. 6 is a schematic depicting a perspective view of the air dispenser luer lock assembly of one embodiment of the bead wash tool of FIG. 5.

FIG. 7 is a schematic depicting a perspective view of a component of the assembly of one embodiment of the bead wash tool of FIG. 5.

FIG. 8 is a schematic depicting a perspective view of the jet dispenser lower luer locks of one embodiment of the bead wash tool of FIG. 5.

FIG. 9 is a schematic depicting a top view of the vacuum and blowdown block puck attachment of one embodiment of the bead wash tool of FIG. 5.

FIG. 10 is a schematic depicting a perspective view of the waste level luer locks of one embodiment of the bead wash tool of FIG. 5.

FIG. 11 is a perspective view of a magnetic base rack for 50 mL Falcon tubes used as a magnetic plate in one embodiment of the dual-head magnetic liquid handler of the invention.

FIG. 12 is a perspective view of a magazine and magnetic base rack of FIG. 11.

FIG. 13 is a perspective view of one embodiment of a magnetic base rack used as a magnetic plate in one embodiment of the dual-head magnetic liquid handler of the invention.

FIG. 14 is a perspective view of a magazine and magnetic base rack of FIG. 13.

FIG. 15 is a top view of a magazine and magnetic base rack of FIG. 13.

FIG. 15A is a top view of a magnetic plate showing stir bars at the base of each tube for agitation of tube contents.

FIG. 16 is a top view of 4 mL beads on a magnetic plate of the invention.

FIG. 17 is a perspective view of a 50 mL tube rack on a magnetic magazine of the invention.

FIG. 18 is a top view of the 50 mL tube rack of FIG. 17.

FIG. 19 is a front view of an embodiment of a magnetic base plate of one embodiment of the invention.

FIG. 20 is a perspective view of the magnetic base plate of FIG. 19.

FIG. 21 is a perspective view of an embodiment of a magnetic base plate in a magazine of one embodiment of the invention.

FIG. 22 is a side view of the magnetic base plate of FIG. 21.

FIG. 23 is a plan view of a magnetic base plate having stir bars in each well for agitating and mixing contents.

FIG. 24 is a perspective view of the components of a positive pressure adapter with a positive pressure adapter holder.

FIG. 25 is a perspective view of the individual components of the positive pressure adapter of FIG. 23.

FIG. 26 is a perspective view of the positive pressure adapter of FIG. 24 loaded on an embodiment of a dual-head magnetic liquid handler system.

FIG. 27 is a perspective view of the positive pressure adapter of FIG. 24 loaded in a positive pressure adapter holder of FIG. 23 on a worktable of an embodiment of a dual-head magnetic liquid handler system.

FIG. 28 depicts several views of one embodiment of an interchangeable bead washing tool head which may be mounted on a robotic arm of the invention.

FIG. 29 depicts several views of one embodiment of an interchangeable positive pressure tool head which may be mounted on a robotic arm of the invention.

FIG. 30 is a perspective view of a single robotic arm embodiment of the magnetic liquid handler system comprising the interchangeable heads of FIGS. 28 and 29.

FIG. 31 is a front elevation view of the single robotic arm embodiment of the magnetic liquid handler system of FIG. 30.

FIG. 32 is a side elevation view of the single robotic arm embodiment of the magnetic liquid handler system of FIG. 30.

FIG. 33 is a perspective view of a dual robotic arm embodiment of the magnetic liquid handler system comprising the interchangeable heads of FIGS. 28 and 29.

FIG. 34 is a front elevation view of the dual robotic arm embodiment of the magnetic liquid handler system of FIG. 33.

FIG. 35 is a side elevation view of the dual robotic arm embodiment of the magnetic liquid handler system of FIG. 33.

FIGURE A through FIGURE AA depict the incremental steps in a process cycle of positive pressure solid phase extraction utilizing the positive pressure adapter of one embodiment of the fully automated anybody purification dual-head magnetic liquid handler system of the invention.

Appendix A discloses certain embodiments of the apparatus, systems and methods of solid phase extraction and positive pressure apparatus and control devices used with certain embodiments of the system of the invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in antibody purification liquid handling systems. Those of ordinary skill in the pertinent art may recognize that other elements may be desirable and/or required in order to implement the present invention. However, because such elements are well known in the art, and because they do not facilitate a better understanding of the present invention, a discussion of such elements is not provided herein.

Reference will now be made in detail to several exemplary and non-limiting embodiments of the present invention, some of which are illustrated in the accompanying drawings.

The present disclosure relates to apparatus, systems, devices, processes, and methods for purifying and otherwise processing and handling antibodies of commercially acceptable quality and in commercially acceptable quantities and wherein the resultant purified molecules may be further processed optimized, and/or used in other manufacturing processes and/or manufactured products.

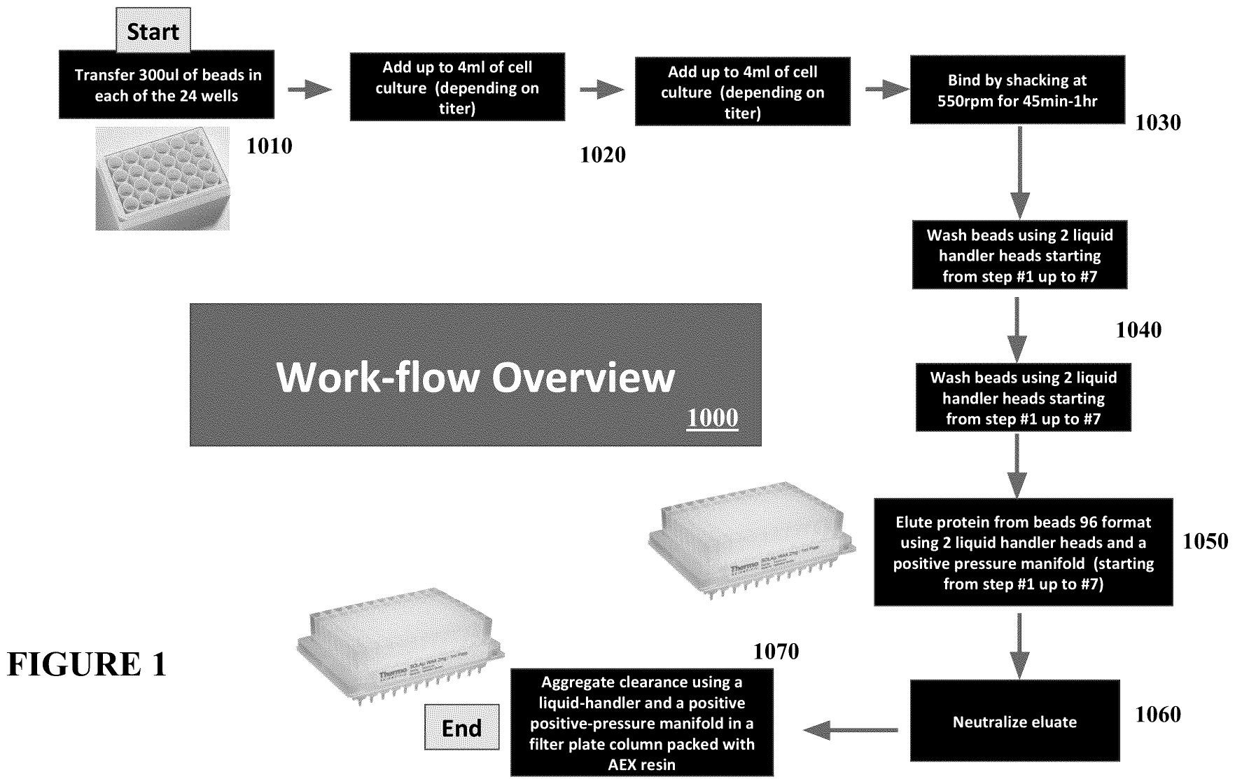

In one embodiment of the invention, depicted in FIG. 1 hereto, the process and system for purifying antibodies 1000 comprises transferring magnetic beads or resin into multiple collection wells for affinity purification of the antibodies at 1010, adding filtered or non-filtered cell culture media to each well at 1020, binding proteins to the beads by shaking or otherwise agitating each well at 1030, washing the beads using two liquid handler heads of the invention at 1040, eluting proteins from the beads using the two liquid handler heads and positive pressure manifold of the invention at 1050, neutralizing the eluate at 1060, and clearing the aggregate using the liquid handler and positive-pressure manifold of the invention from each well containing AEX resin through a filter plate of the invention at 1070.

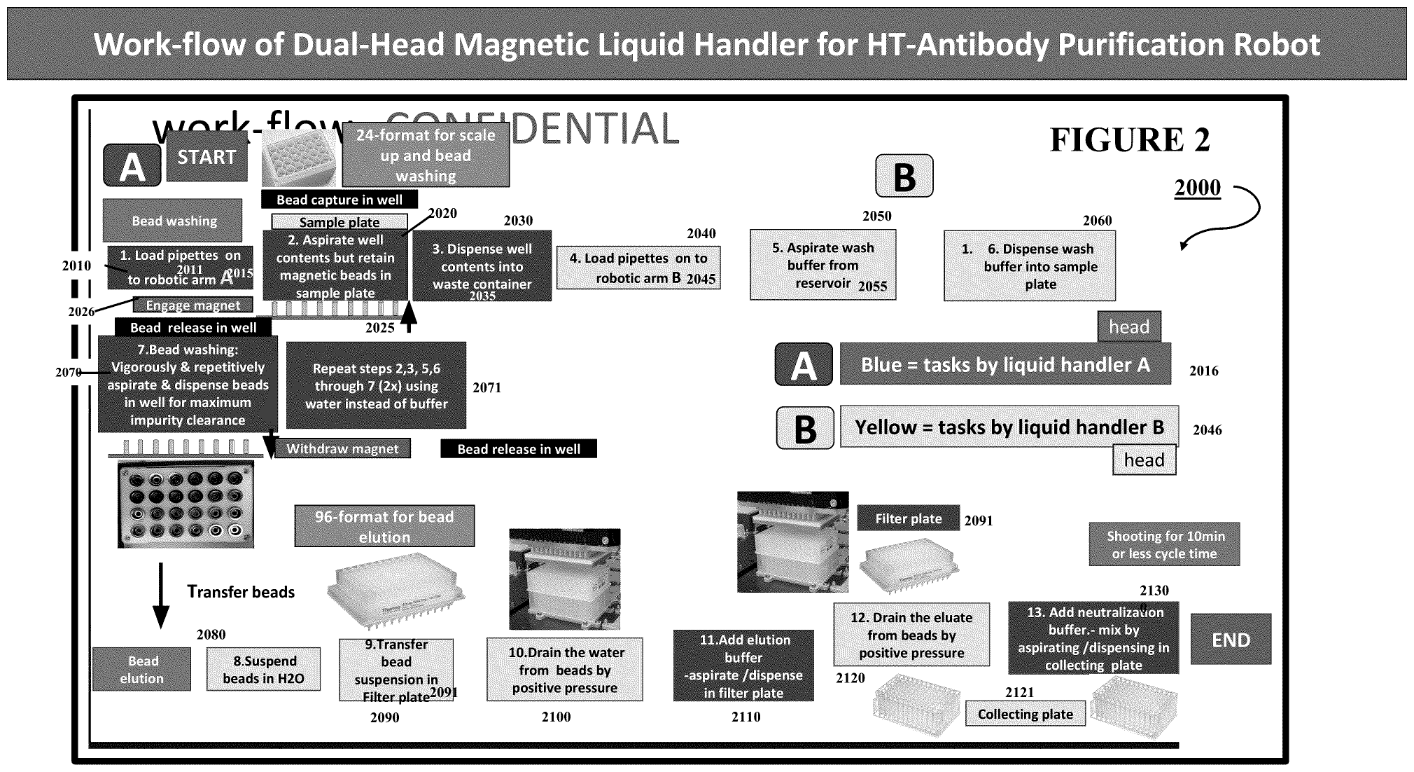

Turning now to FIG. 2, there is shown another embodiment of the process and system for purifying antibodies 2000. System and process 2000 generally comprises a fully automated dual-head magnetic liquid handler which provides purification of antibodies utilizing high throughput techniques.

In one embodiment, system and process 2000 may comprise one or more of the following elements and/or steps:
1. At 2010, and as part of the magnetic bead washing process of beads 2012, loading a desired array of pipettes 2011 onto first robotic arm 2015 comprising a first magnetic liquid handler head 2016.
2. At 2020, sample magnetized plate 2025, comprising one or more wells 2027, is prepared by capturing magnetic beads 2012 in an array of wells 2027, which wells 2027 of magnetized plate 2025 may equal the number of pipettes 2011, engaging or energizing magnet 2026, and/or aspirating the contents of wells 2027 while retaining magnetic beads 2012 in sample plate 2025 using first magnetic liquid handler head 2016. In one embodiment, the array of wells 2027 may be in a 24 well array.
3. At 2030, dispensing the contents of each well 2027 into waste container 2035 using first magnetic liquid handler head 2016.
4. At 2040, loading pipettes 2011 onto second robotic arm 2045 comprising second magnetic liquid handler head 2046.
5. At 2050, aspirating wash buffer from reservoir 2055 using pipettes 2011 loaded on second magnetic liquid handler head 2046;
6. At 2060, dispensing wash buffer from reservoir 2055 via pipettes 2011 into wells 2027 of sample plate 2025 using second magnetic liquid handler head 2046.
7. At 2070, and as part of the bead washing process, withdrawing or deenergizing magnet 2026 therein releasing magnetized beads 2012 in wells 2027, vigorously and, as necessary or desired, repetitively aspirating and dispensing beads 2012 in wells 2027, with the goal of achieving maximum possible impurity clearance using first magnetic liquid handler head 2016. At 2071, repeat steps 2, 3, 5, 6 and 7 (each step corresponding to 2020, 2030, 2050, 2060 and 2070) one or more times as necessary or desired, using water instead of buffer.
8. At 2080, and as part of a bead 2012 elution process, transfer magnetic beads 2012 from first magnetic liquid handler head 2016 to second magnetic liquid handler head 2046 into an H₂O suspension.
9. At 2090, transfer the H₂O bead suspension in filter plate 2091 using second magnetic liquid handler head 2046. In one embodiment, filter plate 2091 may comprise a 96 well array.
10. At 2100, drain the water from the H₂O bead suspension by applying positive pressure to the wells of filter plate 2091 using second magnetic liquid handler head 2046. Certain embodiments of a positive pressure adaptor described more fully herein may be utilized to drain the water from the H₂O bead suspension.
11. At 2110, add elution buffer to the wells of filter plate 2091, and aspirate and dispense the eluate in the wells of filter plate 2091 using first magnetic liquid handler head 2016.
12. At 2120, drain the eluate from the magnetic beads 2012 in the wells of filter plate 2091 by positive pressure into the wells of collecting plate 2121 using the second magnetic liquid handler head 2046.
13. At 2130, add neutralization buffer to wells of collecting plate 2121. Mix eluate and neutralization buffer in wells of collecting plate 2121 by aspirating and dispensing eluate and buffer in collecting plate using the first magnetic liquid handler head 2016.

In the various embodiments, the magnetic liquid handlers of the invention operate at speeds far superior to that of existing systems. Generally, overall cycle times of system 2000 may be determined, in part, by the particular chemistry and/or incubation times required by the particular processing to be accomplished. In addition, the number of specimens being contemporaneously processed (such as, for example, sample plates comprising arrays of 6, 24 or 96 sample wells) may also impact the processing cycle times per sample well or tube).

For example, in certain embodiments, the magnetic liquid handlers of the invention are capable of purifying in excess of about 8000 antibodies in approximately eight hours while existing systems are limited to purifying only approximately 700 antibodies in a similar timeframe. Also, in certain embodiments of the invention, the cycle time of system 2000 may be ten minutes or less.

In other embodiments of the invention, system 2000 may process a full batch of 48samples in less than about 2 minutes per sample on average. In contrast, competing systems processing similar samples are only capable of processing about 2 samples at a time, thereby processing at a rate of approximately 1 sample per hour on average.

Many of the efficiencies realized by dual-head magnetic liquid handler 2000 are achieved as a result of the fully automated and flexible and efficient configuration of system 2000. For example, liquid handler heads 2016 and 2046 may be quickly changed to accommodate various sized sample plates (such as sample plate 2025) in any size array including standard array plate sizes of 6, 24 and 96 wells per plate. In addition, positive pressure adapter 2400, further described herein, enables system 2000 to be run at high efficiencies and low processing times while enabling the rapid conversion of liquid handler heads 2016 and 2046 to plates of various sizes. No other known processing system has such functionality. Each of these unique features individually and collectively result in far higher throughput and far lower per sample processing cycle times than that of other existing systems.

It is also significant, for end users with many samples to process, that the overall cost of the fully automated and continuous processing system 2000 of the present invention relative to the cost of competing batch systems comprising several individual pieces of equipment needed to run the samples in a mostly manual process, is substantially higher than that of system 2000 to provide equivalent capacity.

Additionally, certain embodiments of the apparatus, systems, methods and processes of the invention purify antibodies from either filtered or non-filtered cell culture media.

The embodiments of the magnetic liquid handlers of this invention may use either magnetic beads or resin for affinity purification of antibodies. By way of contrast, known systems are capable of only employing one of either magnetic beads or resin for affinity purification of antibodies.

Certain embodiments of the invention may use a single 96-format plate for the entire purification cycle, while known systems use nine plates per purification cycle.

Certain embodiments of the system of the invention deliver up to about 24 mg of purified anybody's per well, while well-known systems only deliver between approximately 1-2 mgs of antibodies per well.

Embodiments of the system of this invention may be configured to be fully automated from the beginning to the end of antibody purification process, including fully automated magnetic liquid handlers, such that the system does not require human intervention at intermediate steps. One such embodiment is depicted in FIG. 1.

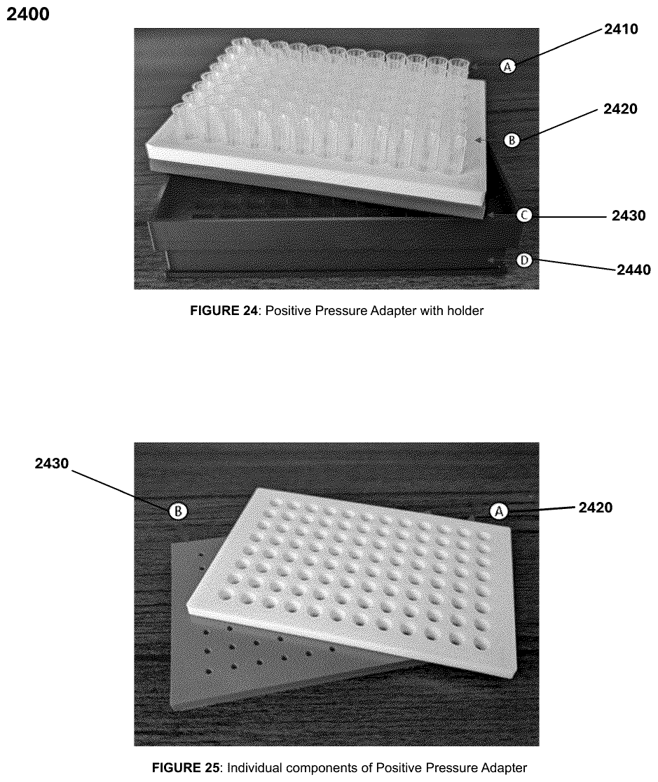

In addition, Figures A through AA depict the incremental steps in the positive pressure solid phase extraction of the process cycle of one embodiment of the automated anybody purification dual-head magnetic liquid handler system 2000. This embodiment may also comprise the positive pressure adapter depicted in FIGS. 24 through 27.

Certain embodiments of system 2000 include magnetic liquid handlers comprising bifunctional positive pressure manifolds for eluting proteins in a concentrated form from the magnetic beads following bead washing by the liquid handler.

Certain embodiments of system 2000 of this invention comprise a magnetic liquid handler which comprises a positive pressure manifold (which may comprise the positive pressure adapter depicted in FIGS. 24 through 27) acting as an antibody plate-purification platform and which uses 96-format filter plates when packed with either affinity resins or magnetic affinity beads and is capable of producing up to approximately about 60 mg of protein per well. Known systems do not provide such functionality.

Certain embodiments of the system of this invention comprise a magnetic liquid handler which comprises a positive pressure manifold (which may comprise the positive pressure adapter depicted in FIGS. 24 through 27) acting as an aggregate clearing device which comprises plate membranes to sieve out the immunogenic antibody aggregates from the monomeric therapeutic antibody product. Known systems do not provide such functionality.

Turning now to FIGS. 24 through 27, there is shown an embodiment of positive pressure adapter 2400 comprising an array of pipette tips 2410 (such as for example Model No. DDX-96-60NF pipette tips available from Dynamic Devices LLC of Wilmington, Delaware); a support plate 2420 (which may in some embodiments comprise ABS plastic having an approximate thickness of 0.25 inches); and gasket 2430 (which may in some embodiments comprise a silicone gasket having a thickness of approximately 0.200 inches and a Shore hardness of approximately 30 A).

In the embodiment of positive pressure adapter 2400 shown in FIGS. 24 through 27, silicone gasket 2430 is adhered to ABS plastic support plate 2420. The cavities within plastic support plate 2420 and silicone gasket 2430 are approximately 9 mm spaced (column and row) to allow for the pipette tips 2410 to be pressed through support plate 2420 and gasket 2430. Pipette tips 2410 may be sheared off below gasket 2430 (˜5 mm).

Positive pressure adapter 2400 may also be stored in SBS footprint holder 2440, having dimensions of approximately 127.8 mm×85.5 mm. Holder 2440 allows positive pressure adapter 2400 to be placed on a worktable of, for example, dual-head magnetic liquid handler 2000.

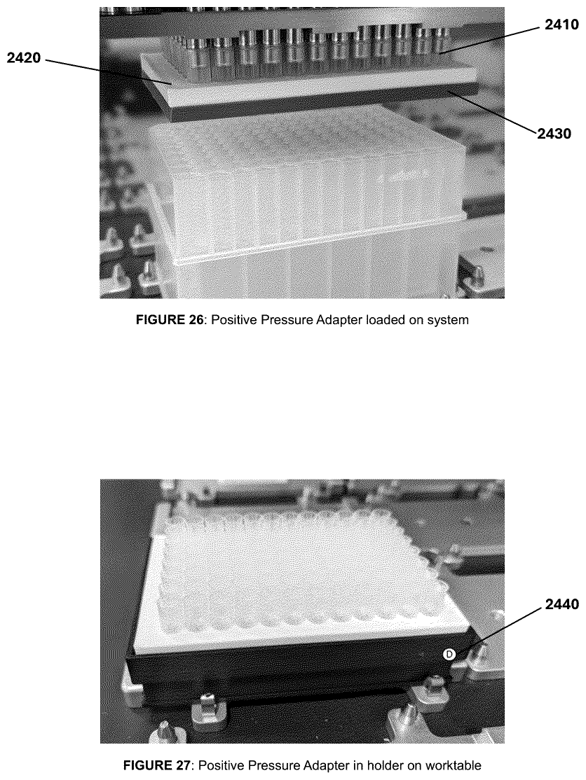

FIG. 26 depicts positive pressure adapter 2400 loaded on liquid handler 2046 and by a 96-channel Volume Verified Pipettor manufactured by Dynamic Devices LLC of Wilmington, Delaware.

FIG. 27 depicts positive pressure adapter 2400 positioned in holder 2440 on a Lynx worktable of dual-head magnetic liquid handler system 2000.

In certain embodiments, positive pressure adapter 2400 may allow Lynx Volume Verified Pipettor (manufactured by Dynamic Devices LLC of Wilmington, Delaware) to perform biochemical applications that require the use of positive pressure within a sealed piece of labware. Common applications may include, but are not limited to, the following:
1. Solid-phase extraction—A sample preparation technique for the extraction of analytes from a complex matrix based on its physical and chemical properties as described in Appendix A hereto.
2. Affinity Chromatography—A method of separating a biomolecule from a mixture, based on the macromolecular binding interaction between the biomolecule of interest and another substance.
3. Rapid Evaporation—Continuous positive pressure to recover solid solute dissolved in a volatile solution.
4. Protein Precipitation.

Positive pressure adapter 2400 may be used as part of automated liquid handling platform 2000 of this invention. In one embodiment, positive pressure adapter 2400 may be used as part of the Lynx automated liquid handling platform 2000 (manufactured by Dynamic Devices LLC of Wilmington, Delaware).

As shown in the embodiment of FIG. 26, positive pressure adapter 2400 is loaded onto a 96-channel pipette tool and programmed to move to a stack of labware containing filter plate 2091 of 96 samples. The pipette tool lowers to the labware stack, sealing the filter plate 2091. Positive pressure is applied to selected channels of the pipette tool, forcing the liquid samples through filter plate 2091 and into a collection plate 2121. Depending on the labware, pressure is monitored throughout the process to determine when liquid has completely passed through filter plate 2091 at which point a channel associated with the sample will stop applying positive pressure. The pipette tool then ejects positive pressure adapter 2400 back into holder 2440 on the worktable of automated liquid handling platform 2000. Certain embodiments of this operation may be fully automated and controlled by the positive pressure system described in Appendix A hereto.

Moreover, because the material used for rubber gasket 2430 is generally non-porous, the silicone seal may be cleaned and sterilized with approximately 80% ethanol either manually or while loaded on a pipette tool. This feature provides reusability to users who process multiple 96-well sample plates in one process.

Unlike existing liquid handling systems which require manual loading and unloading of various plates onto the device, one plate at a time, certain embodiments of liquid handling system 2000 of the present invention comprise a worktable having a footprint which allows for multiple plates to be processed in one batch. In certain embodiments liquid handling system 2000 may automatically process between about 15 and 60 plates.

Also, existing liquid handling systems require that the liquid is manually transferred to the labware prior to loading on to the system. However, positive pressure adapter 2400 of the instant invention comprises a fully automated system that not only applies positive pressure, but also automatically performs all of the liquid handling required to fill the labware prior to processing.

Furthermore, the pressure (or vacuum) applied by positive pressure of liquid handling system 2000 may be spread across the entire piece of labware. In this regard, certain embodiments of the liquid handlers, positive pressure manifolds, and positive pressure adapters 2400 of liquid handling system 2000 enables individual control of each of the 96 channels of a Volume Verified Pipettor (manufactured by Dynamic Devices LLC of Wilmington, Delaware) which enables users to select which channels to activate and/or deactivate based on the layout of the labware as more fully described in Appendix A hereto.

In addition, depending on the labware type, flow sensors within each of the 96 channels of a Volume Verified Pipettor (manufactured by Dynamic Devices LLC of Wilmington, Delaware) may determine if all liquid has flowed through the plate. When the flow sensor senses that all liquid has flowed through the plate, the channel valve associated with that sample closes and positive pressure is no longer applied to that sample. This valve actuation may help in preventing filter plates from drying out during sample processing.

Certain embodiments of liquid handling system of this invention comprise magnetic liquid handler 2000 which comprises a positive pressure manifold which senses when each individual pipette has been filled or drained by employing pressure sensitive feedback from each individual pipette to the system computerized controller enabling precise control over the volume of liquid present in each individual pipette at any given time during the purification process. See Appendix A. Known systems do not provide such functionality.

The embodiments of the system of this invention may also comprise a dual-head liquid handler. One such embodiment comprises two liquid handler heads capable of rapid pipetting of wash buffers into and wash removal from the plates. Known systems do not provide such functionality.

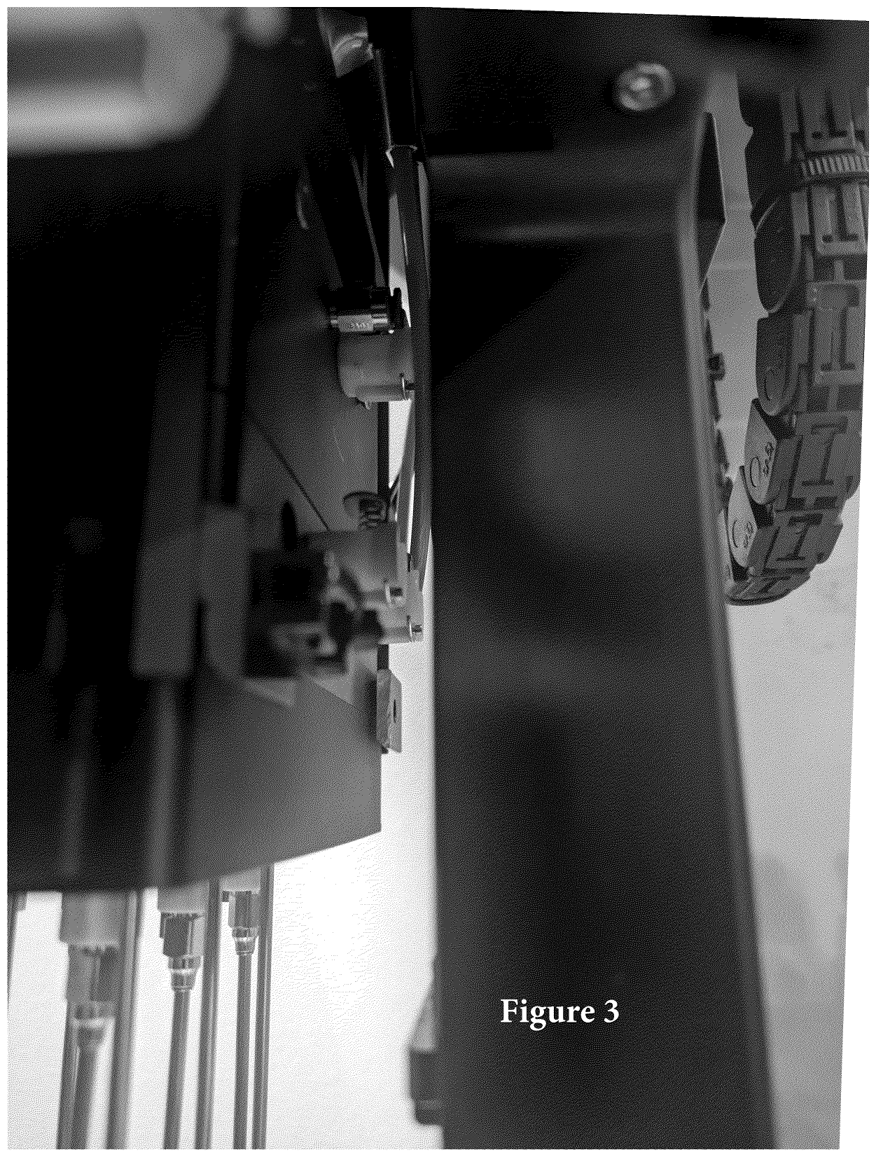

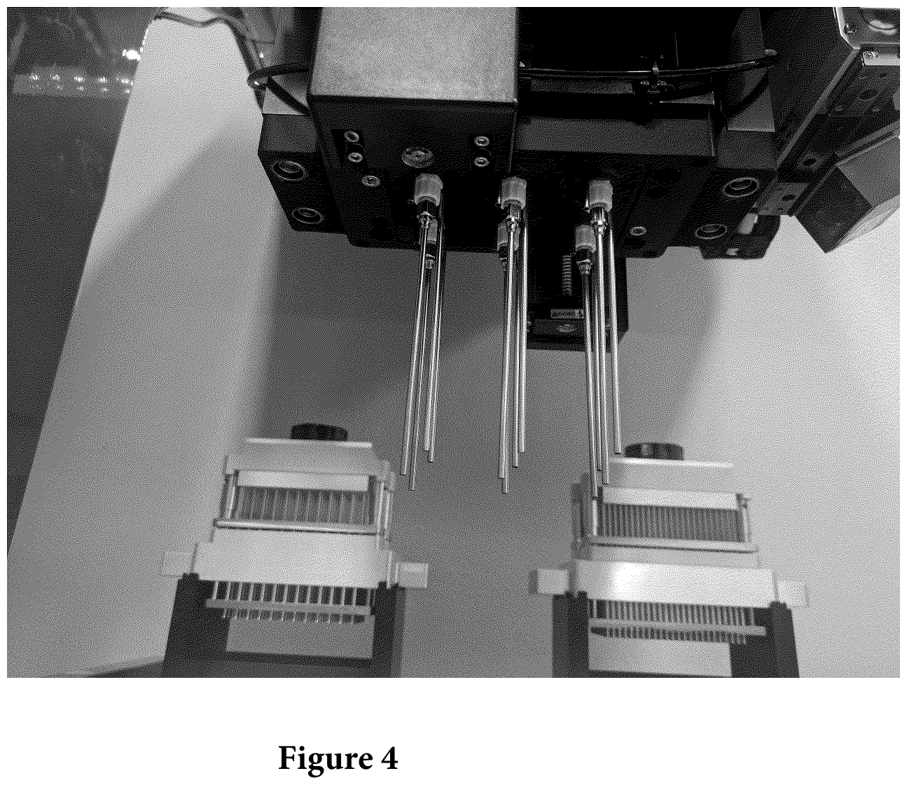

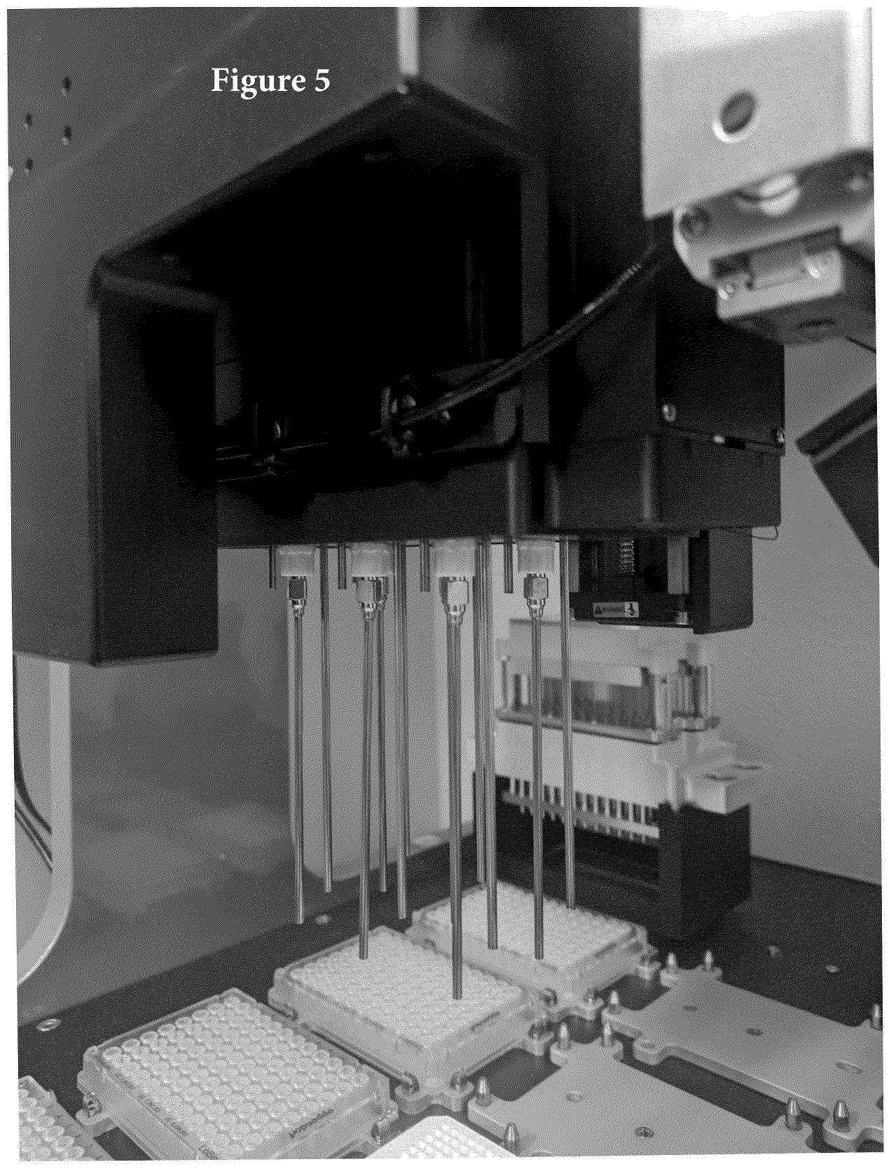

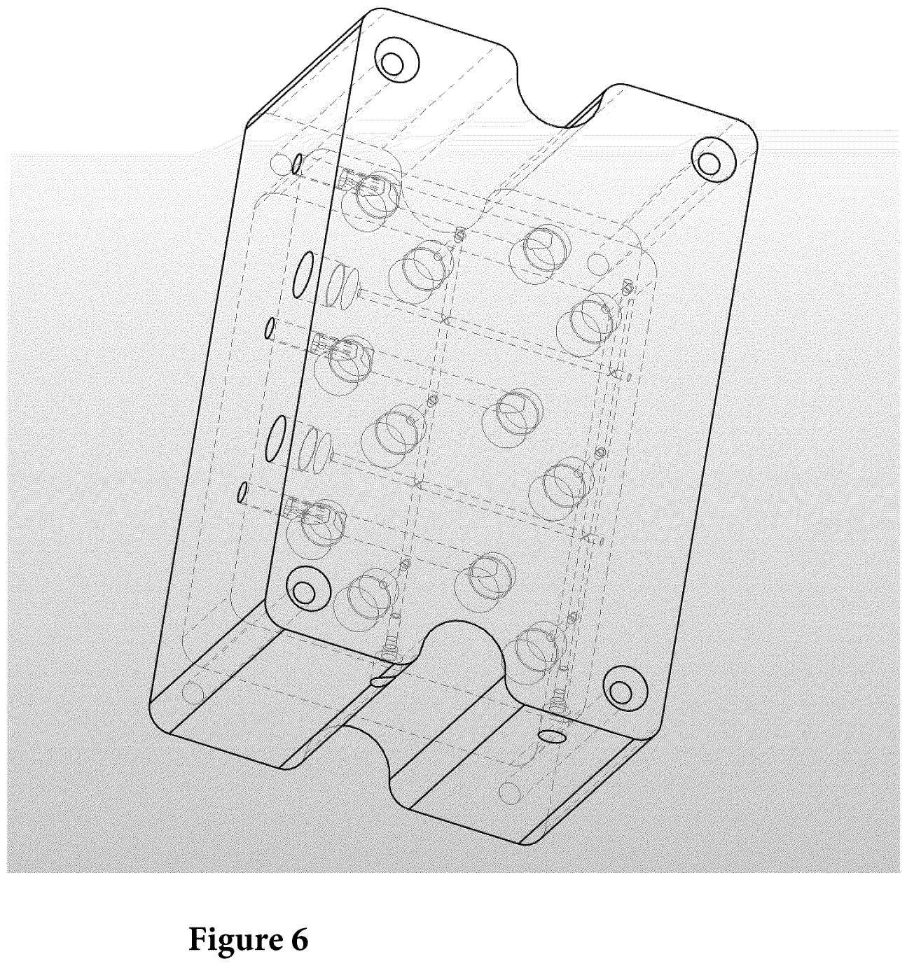

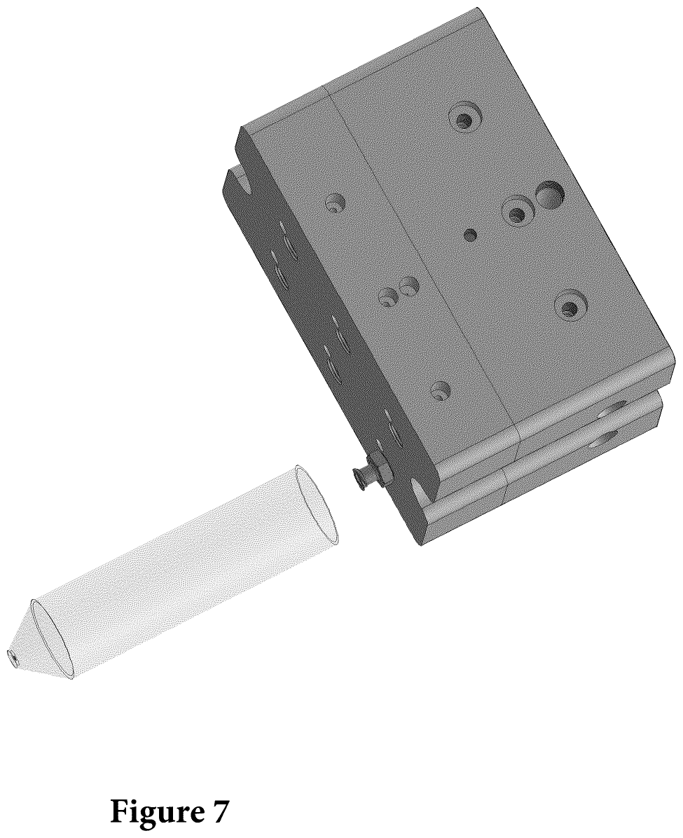

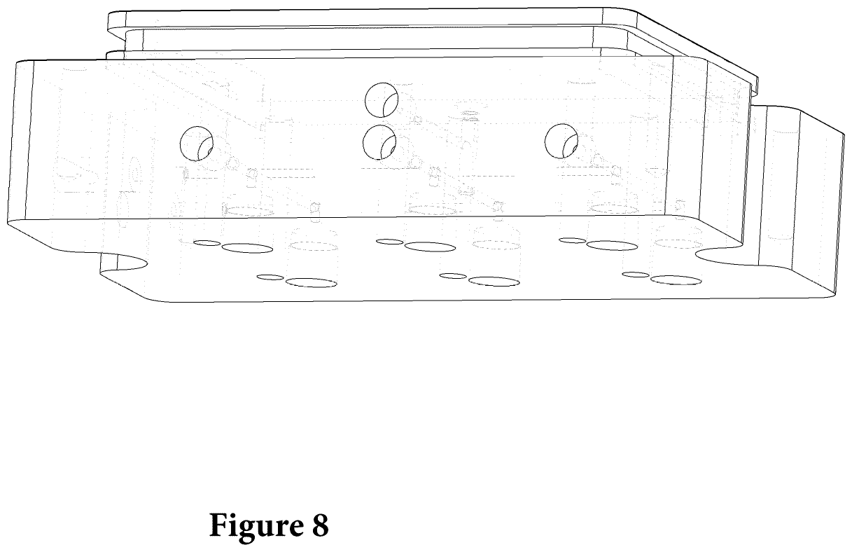

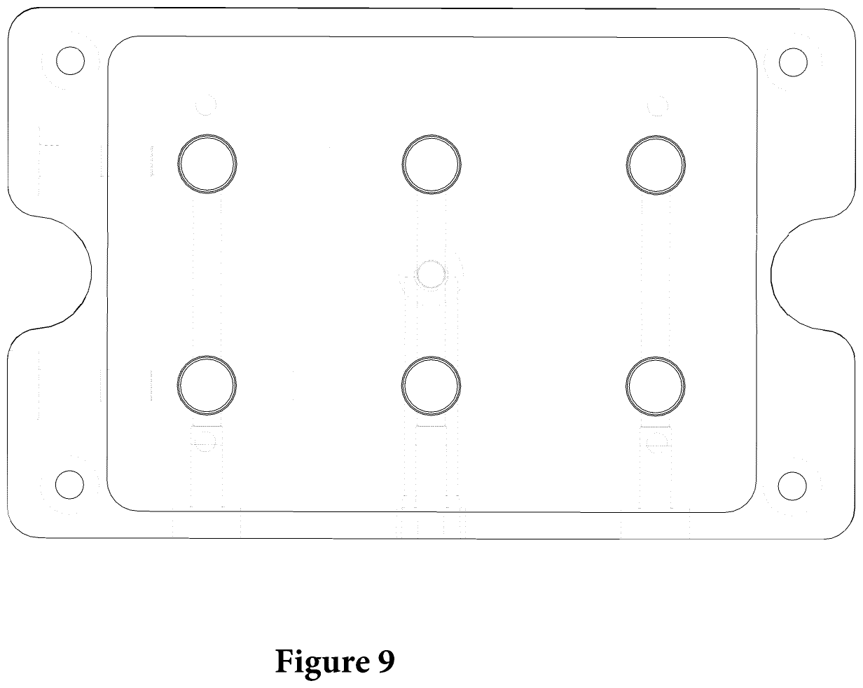

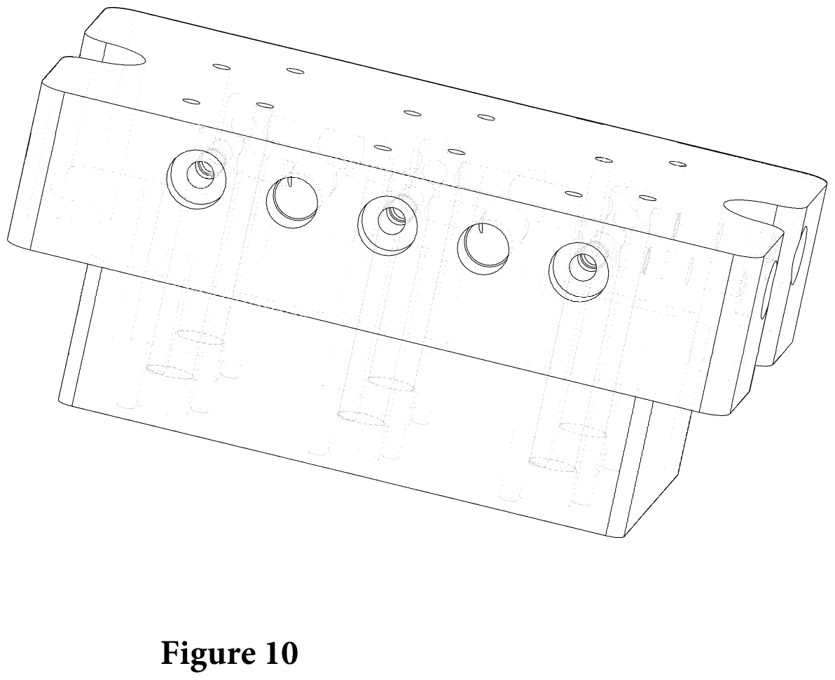

FIGS. 3 through 10 depict various components of the bead washing function of liquid handling system 2000. FIGS. 3 through 5 depict various views of one embodiment of the bead wash tool of one embodiment of the invention. FIG. 6 depicts an embodiment of the air dispenser luer lock assembly. FIG. 7 depicts one embodiment of the bead wash tool of FIG. 5. FIG. 8 depicts an embodiment of the jet dispenser lower luer locks of the bead wash tool of FIG. 5. FIG. 9 depicts an embodiment of the vacuum and blowdown block puck attachment of the bead wash tool of FIG. 5. FIG. 10 depicts an embodiment of the waste level luer locks of the bead wash tool of FIG. 5.

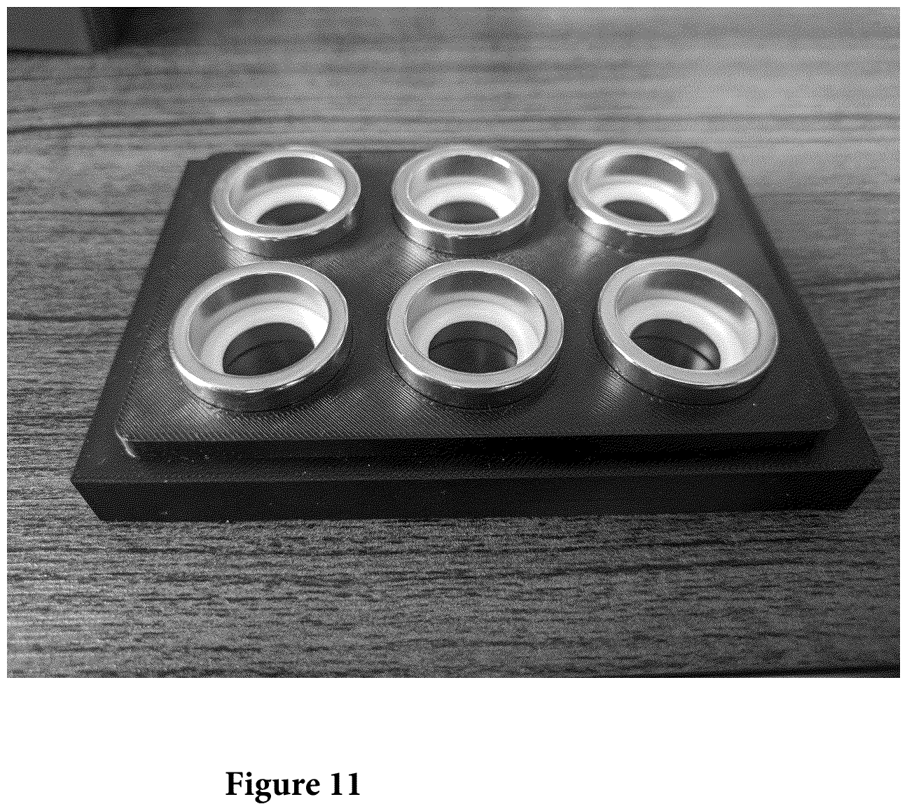

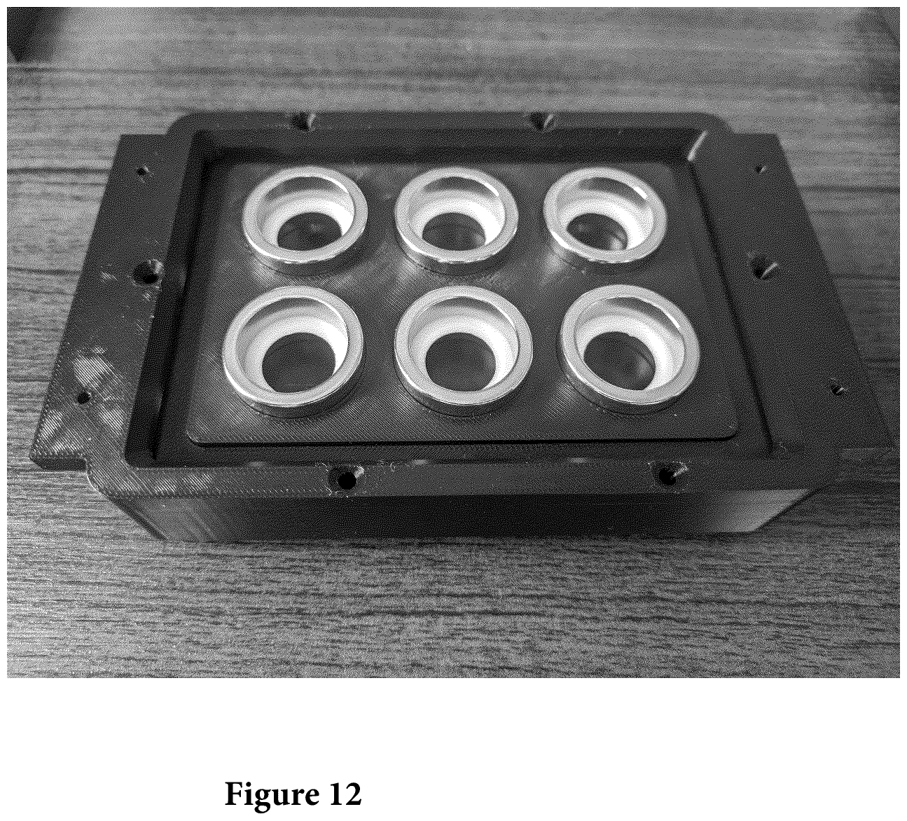

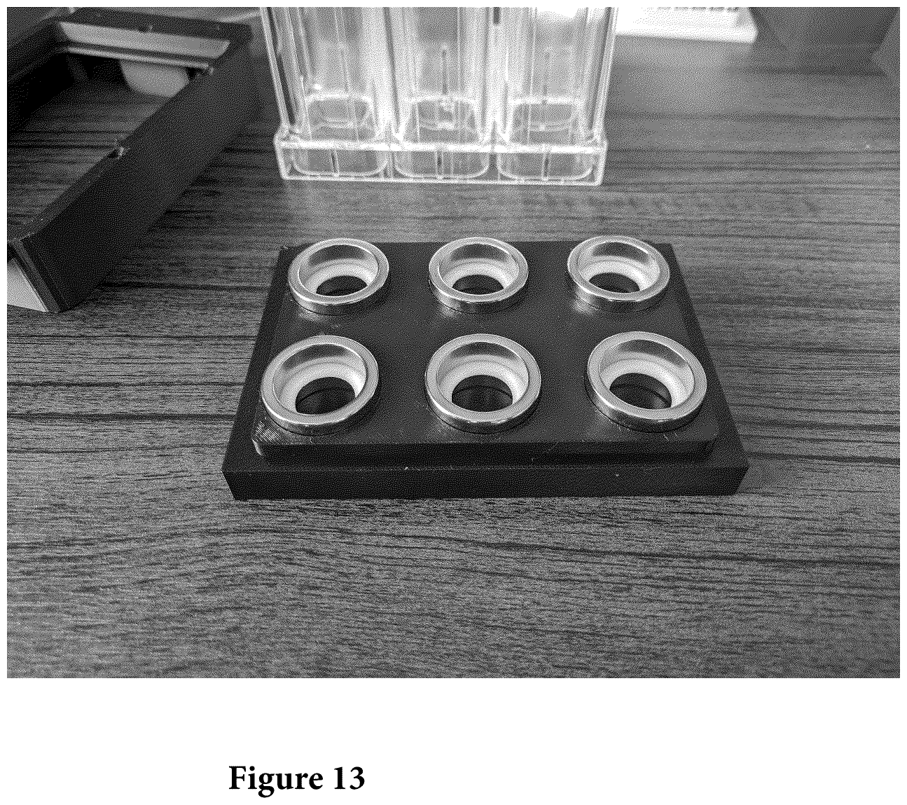

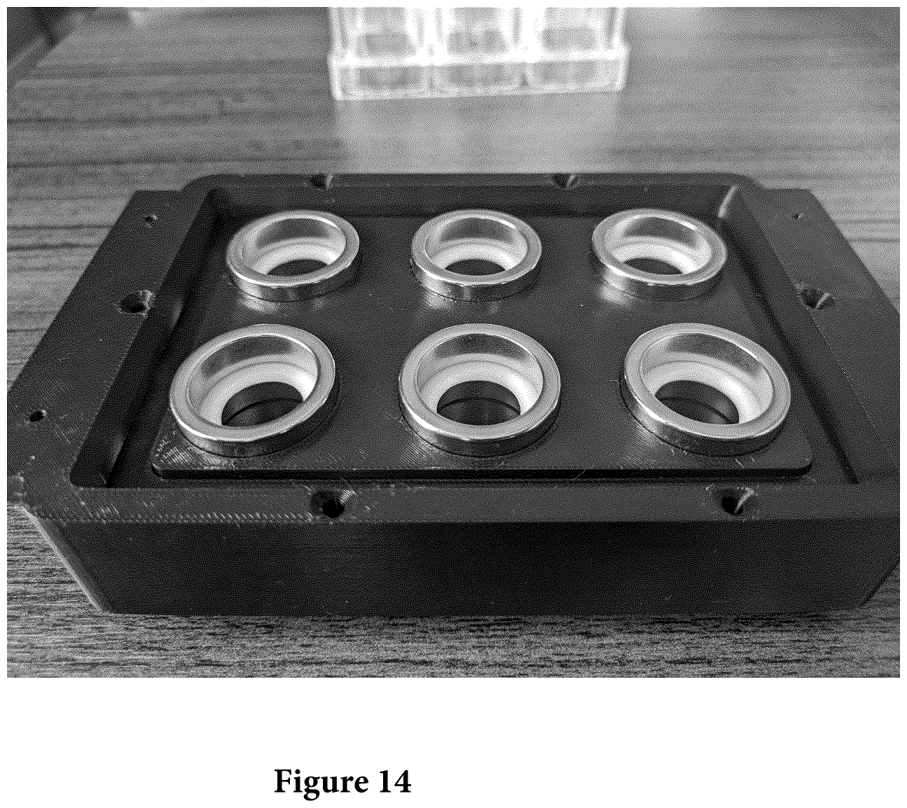

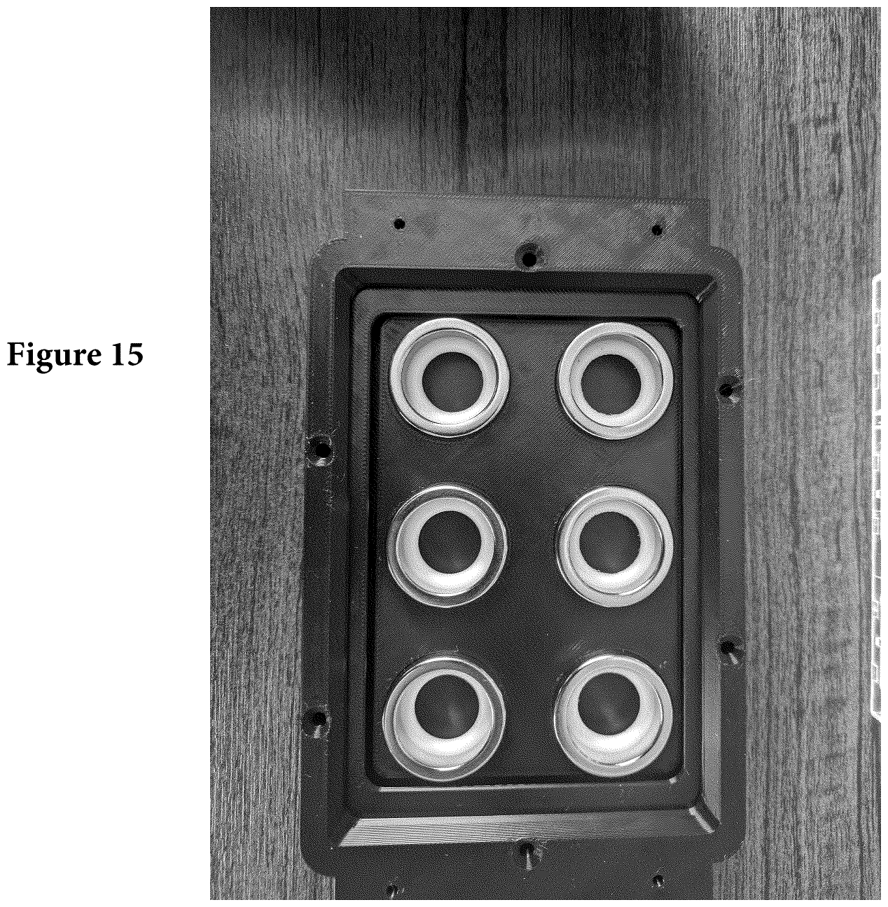

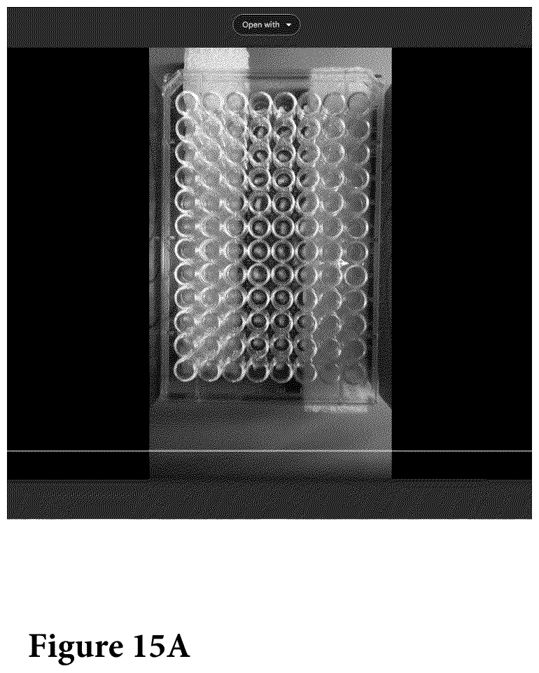

FIGS. 11 through 15 depict various components of the magnetic plates utilized in dual head magnetic liquid handling system 2000. FIG. 11 depicts a magnetic base rack for 50 mL Falcon tubes used as a magnetic plate in one embodiment of liquid handling system 2000. FIG. 12 depicts one embodiment of a magazine and magnetic base rack of FIG. 11. FIGS. 13, 14 and 15 depict various views of one embodiment of a magnetic base rack used as a magnetic plate utilized in dual-head magnetic liquid handler 2000. FIG. 15A depicts one embodiment of a magnetic base plate having stir bars in each well for agitating and mixing contents.

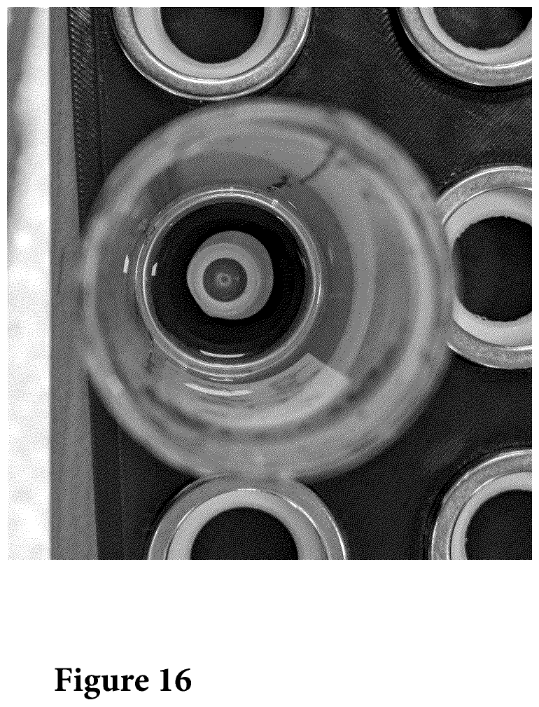

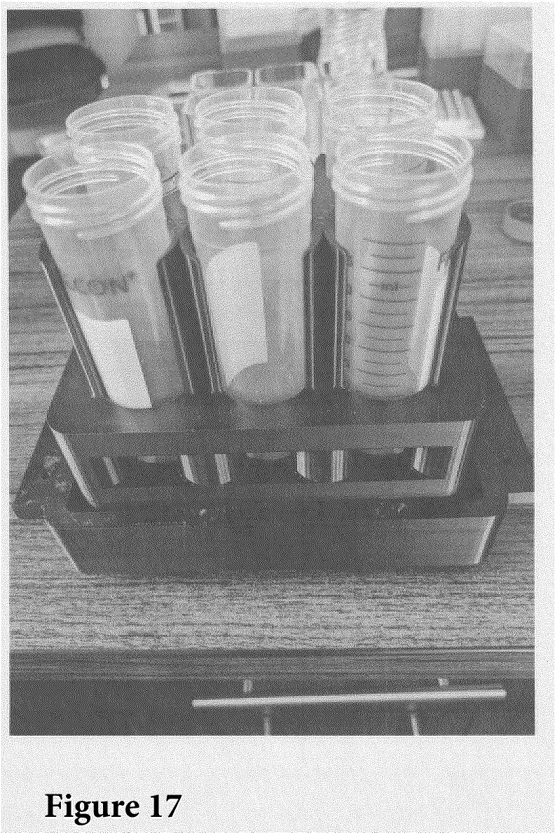

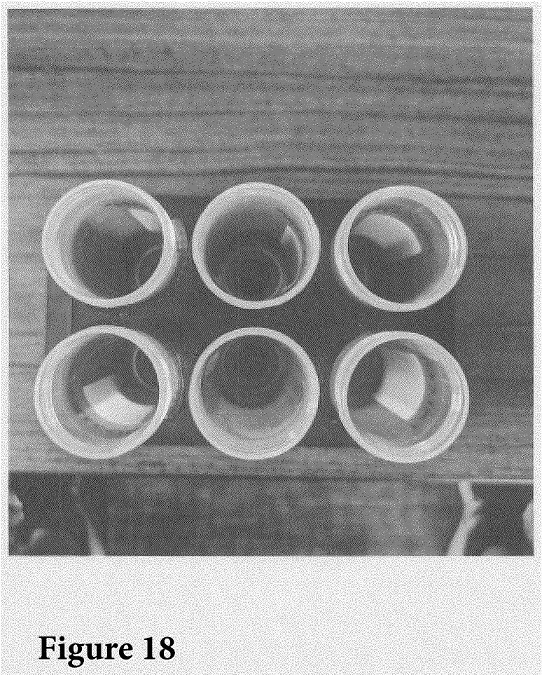

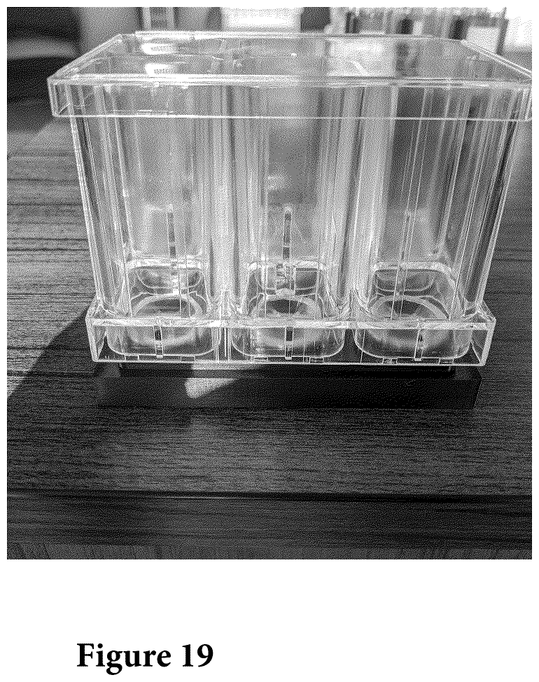

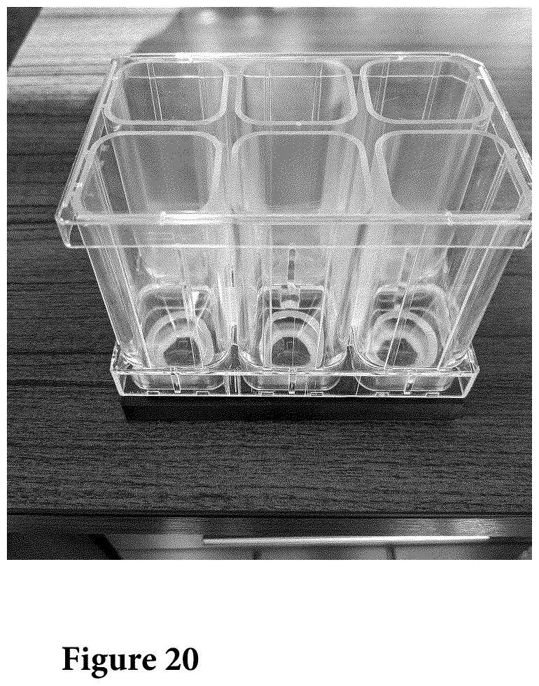

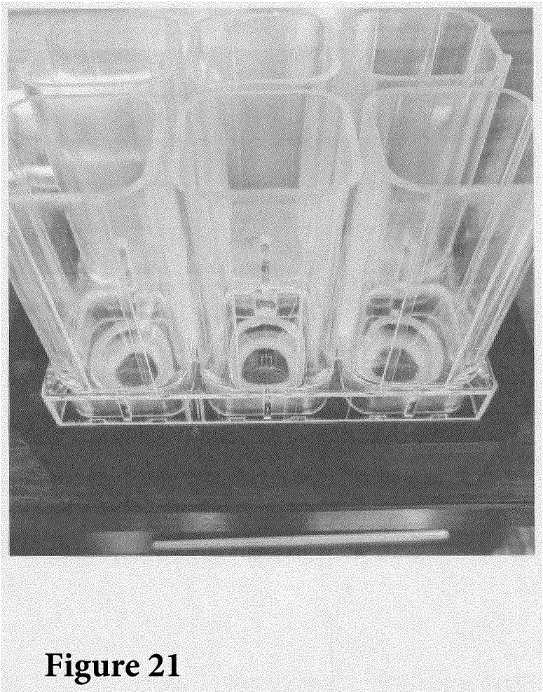

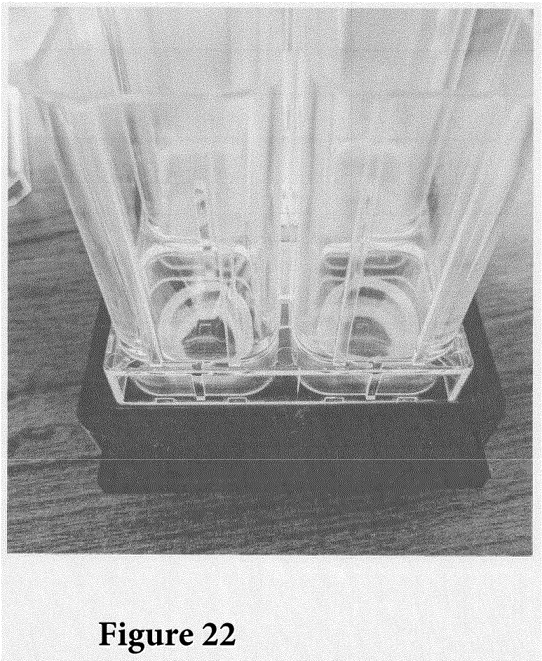

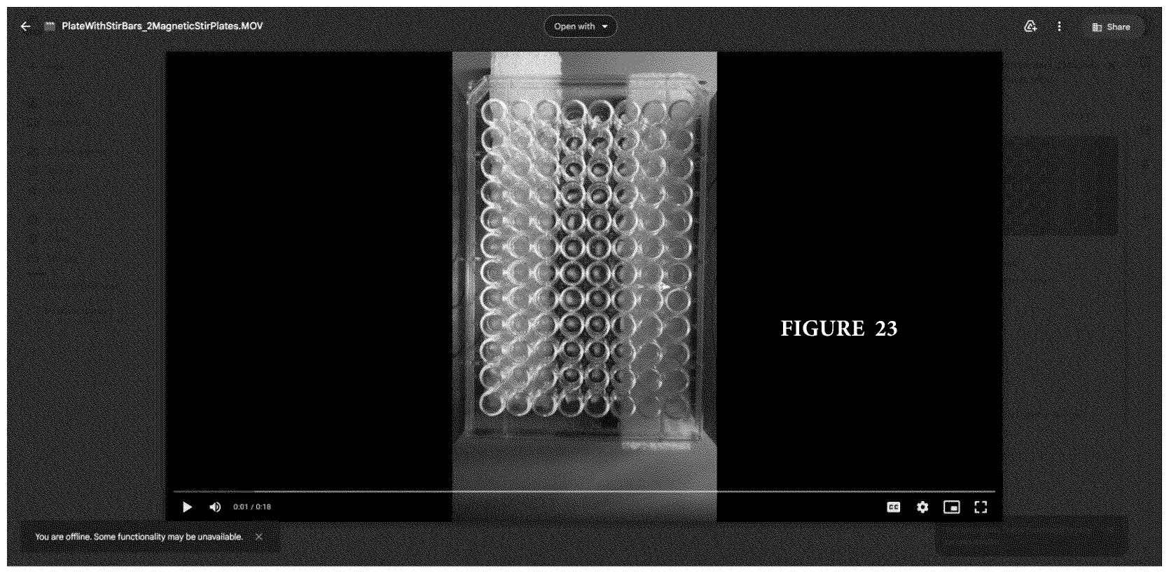

FIG. 16 depicts is one embodiment of 4 mL beads on a magnetic plate of liquid handling system 2000. FIGS. 17 and 18 depict one embodiment of a 50 mL tube rack on a magnetic magazine of liquid handling system 2000. FIGS. 19 and 20 depict an embodiment of a magnetic base plate of one embodiment of the invention. FIGS. 21 and 22 depict an embodiment a magnetic base plate in a magazine of liquid handling system 2000.

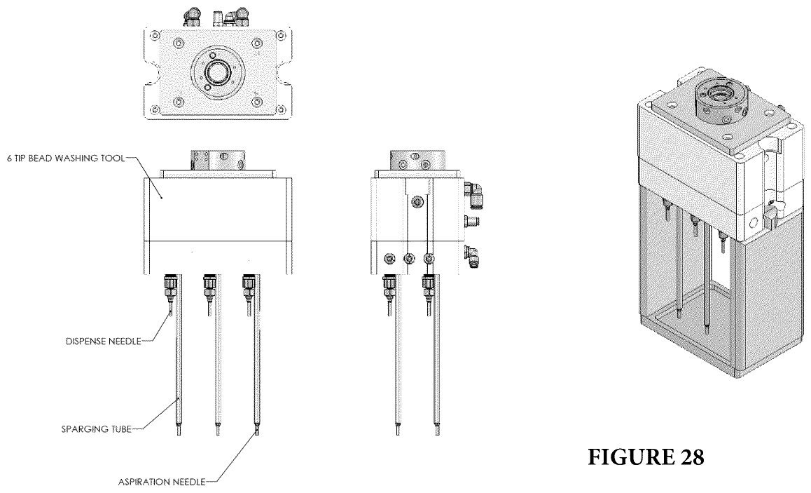

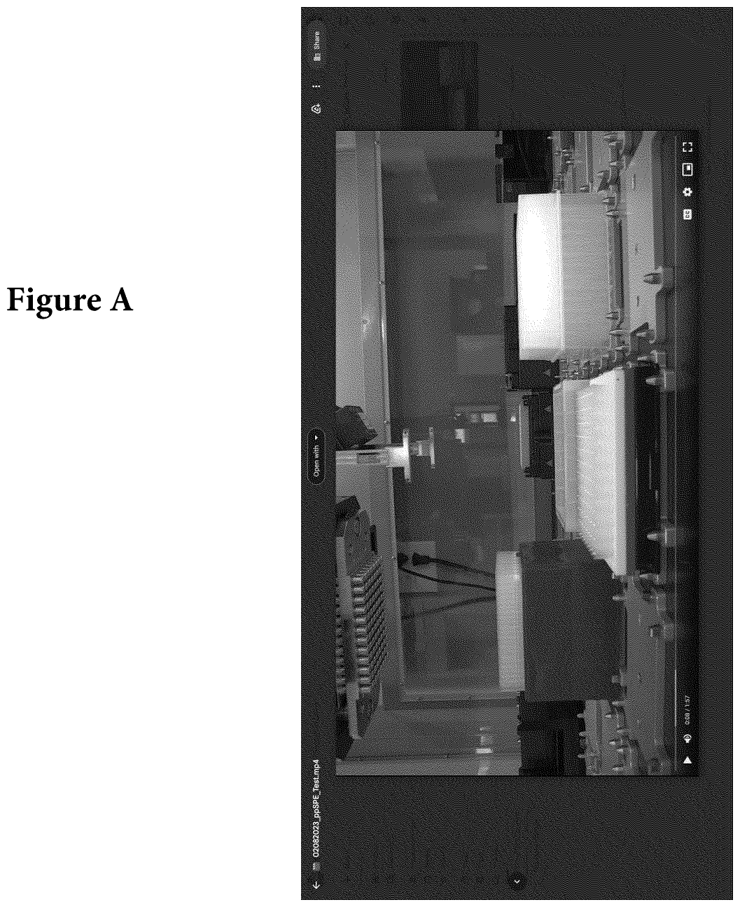

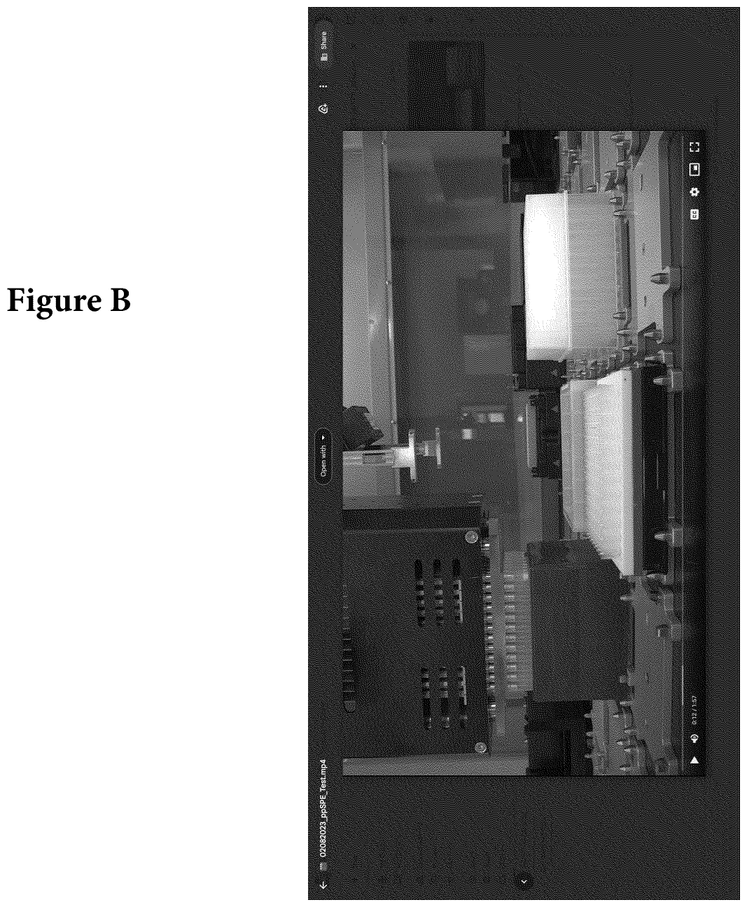

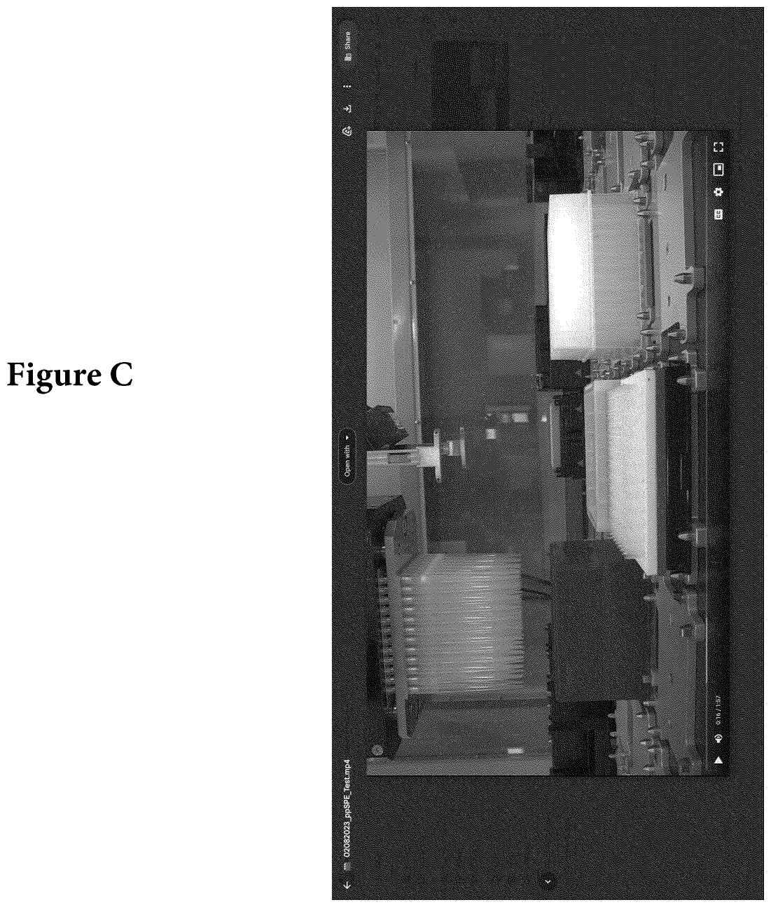

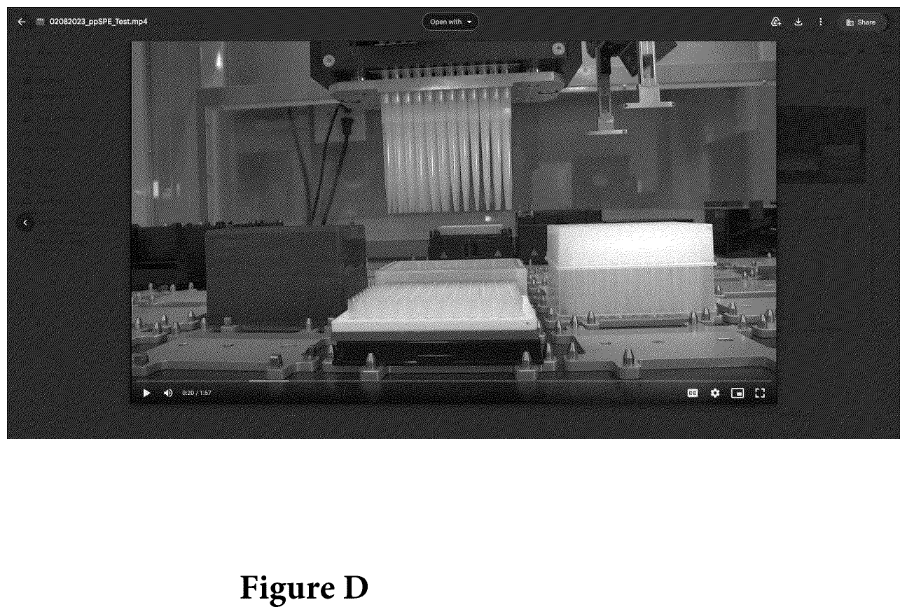

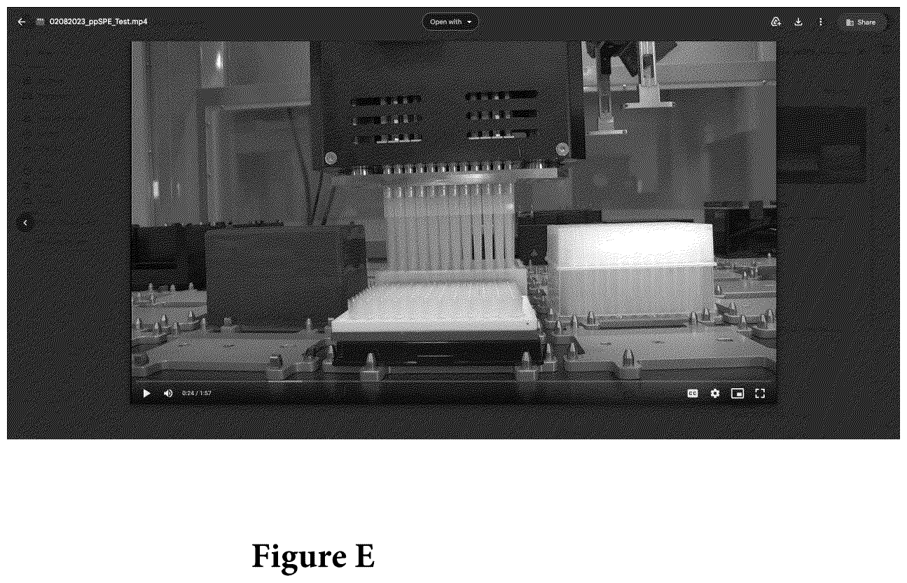

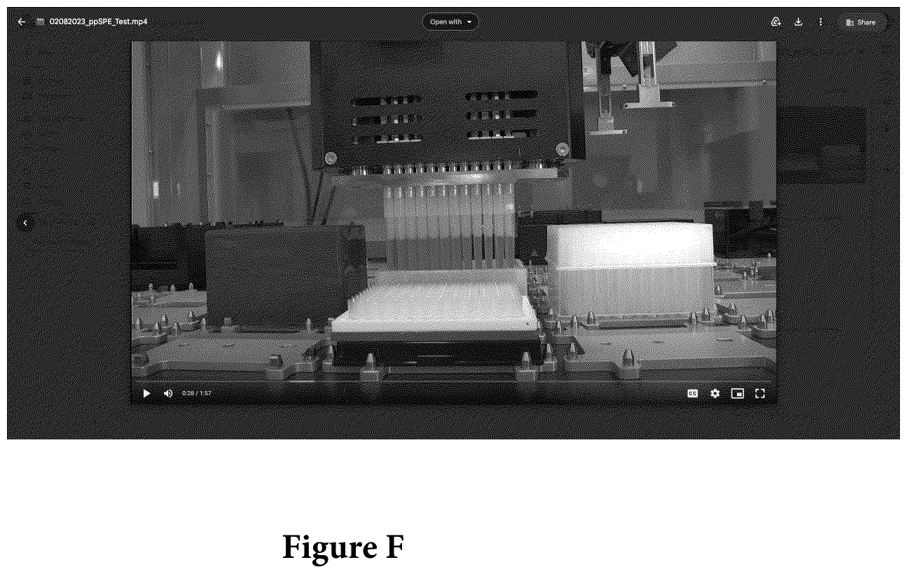

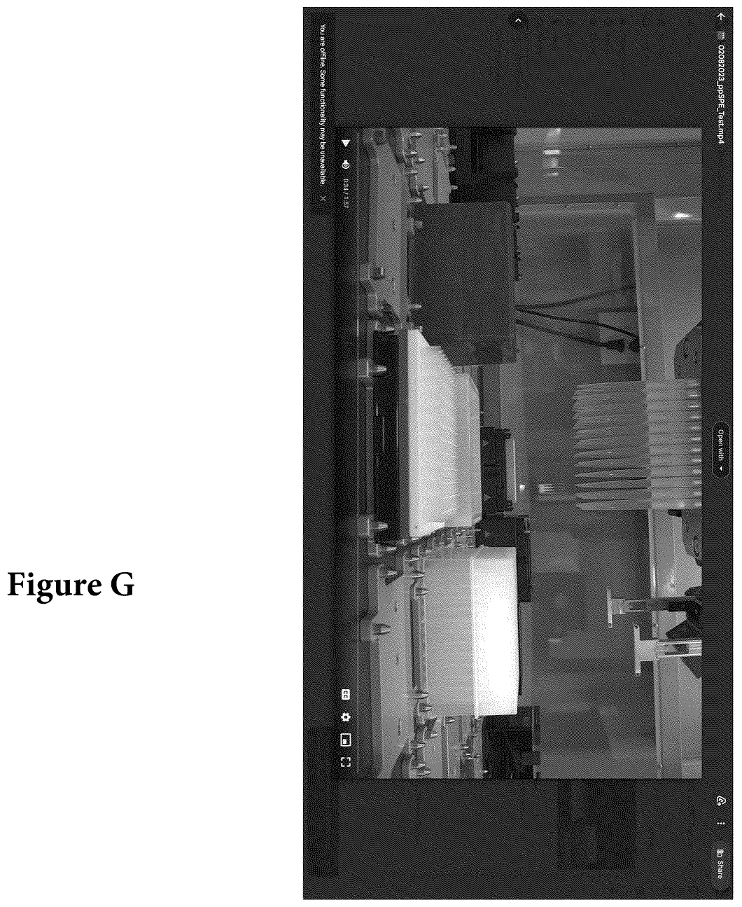

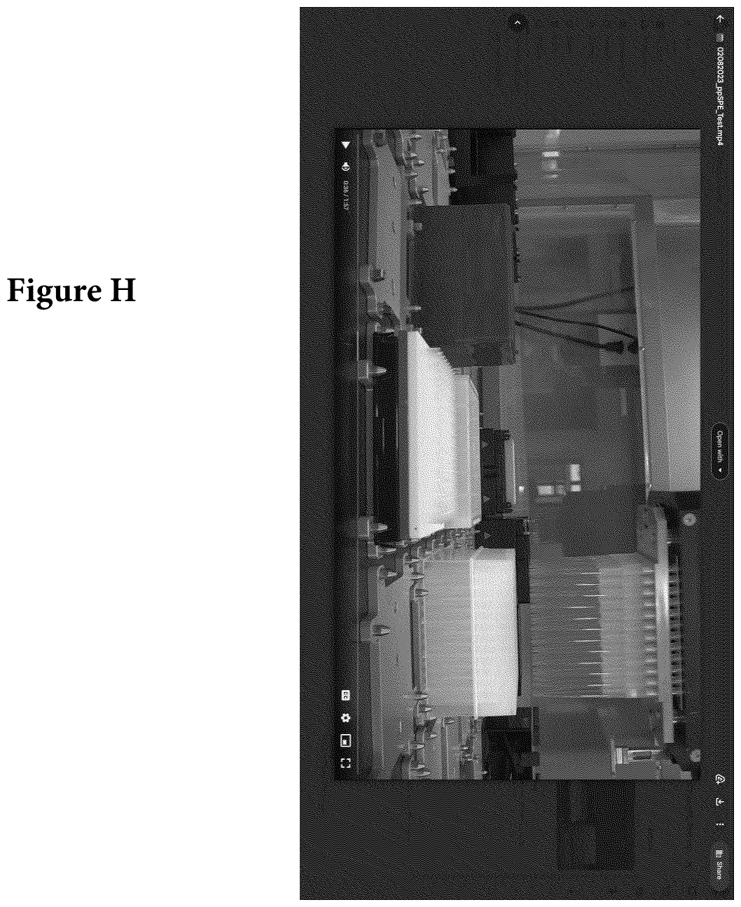

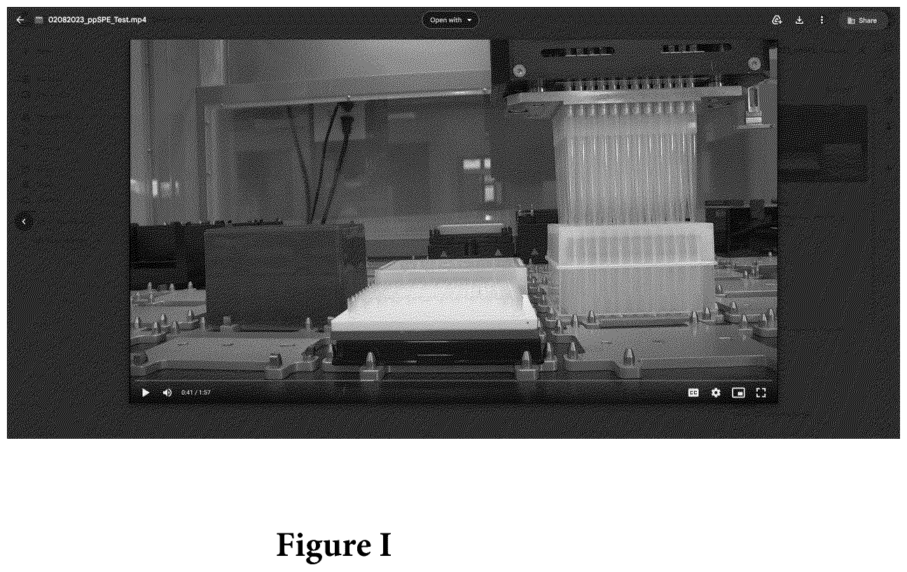

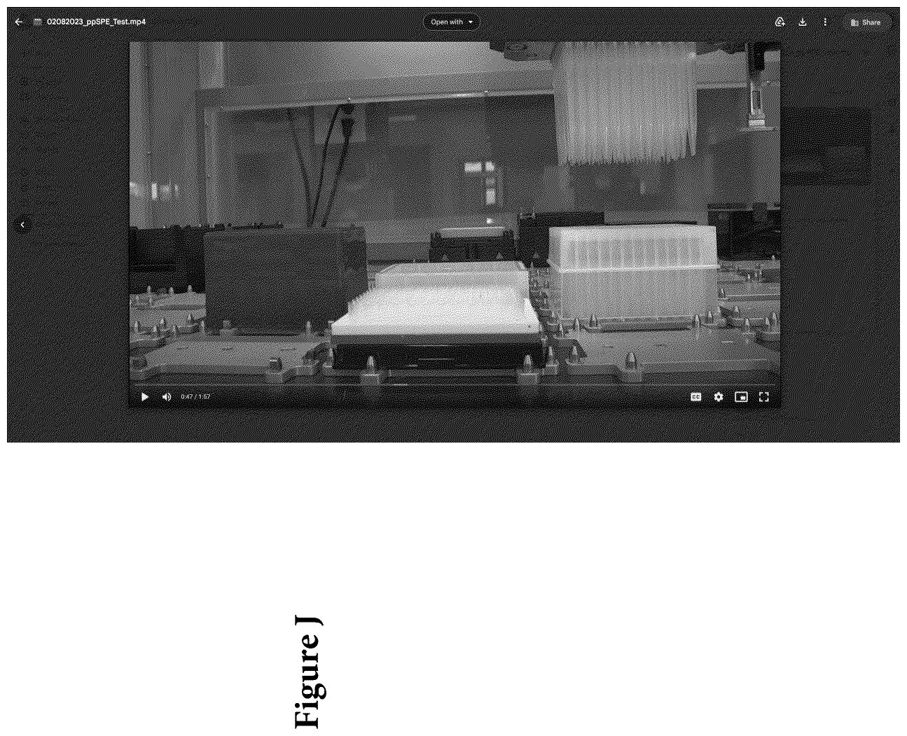

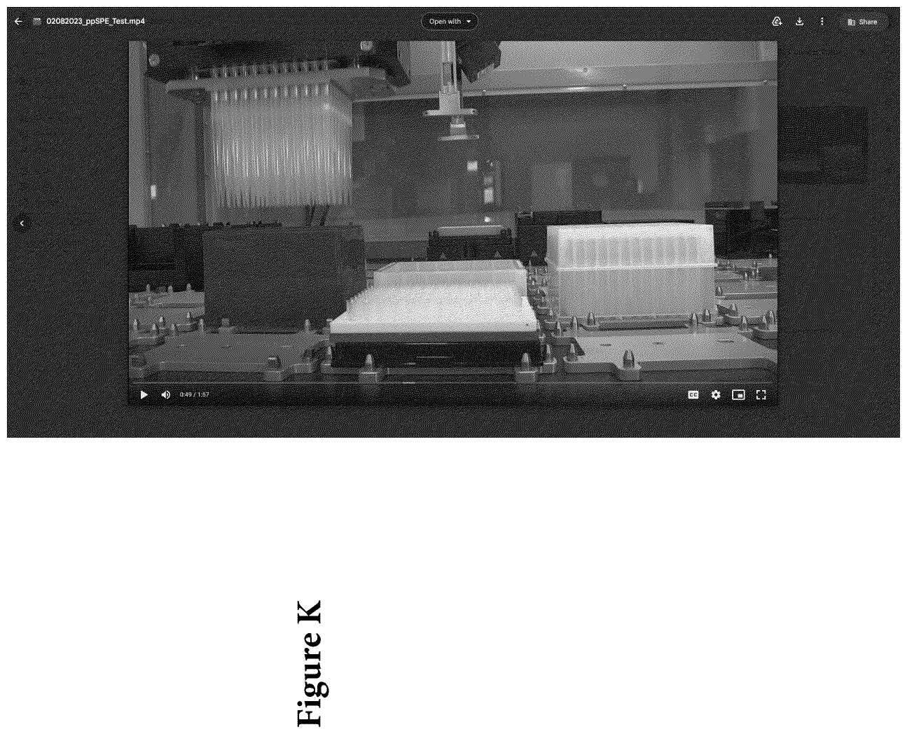

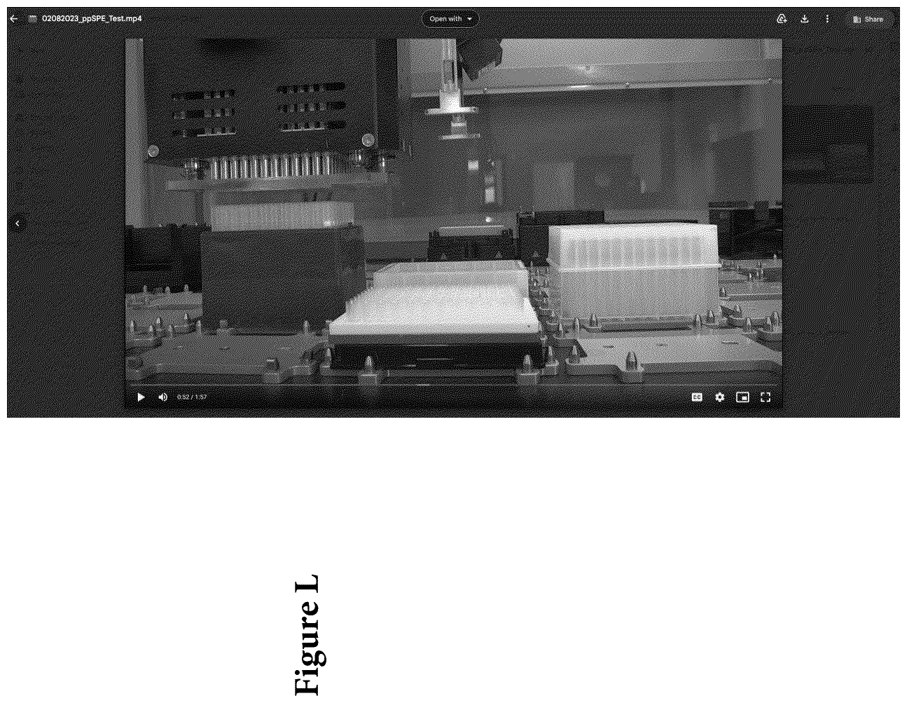

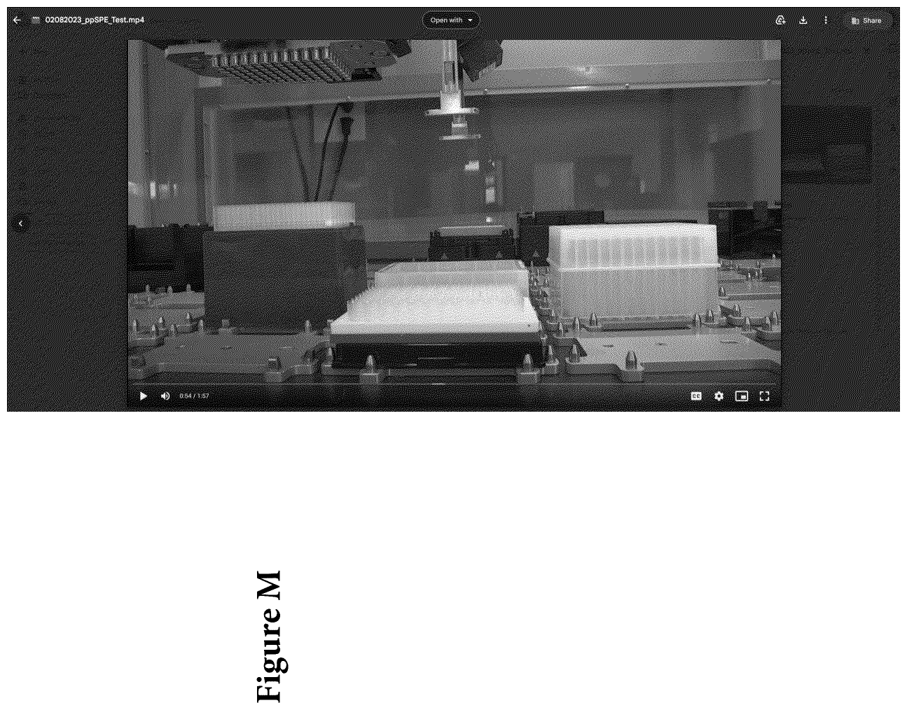

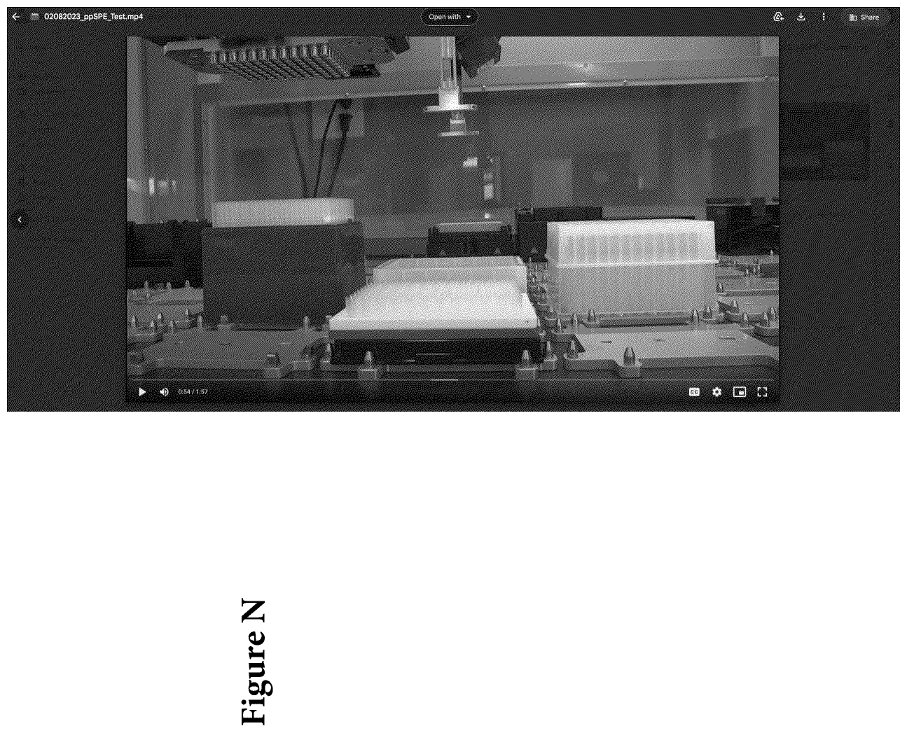

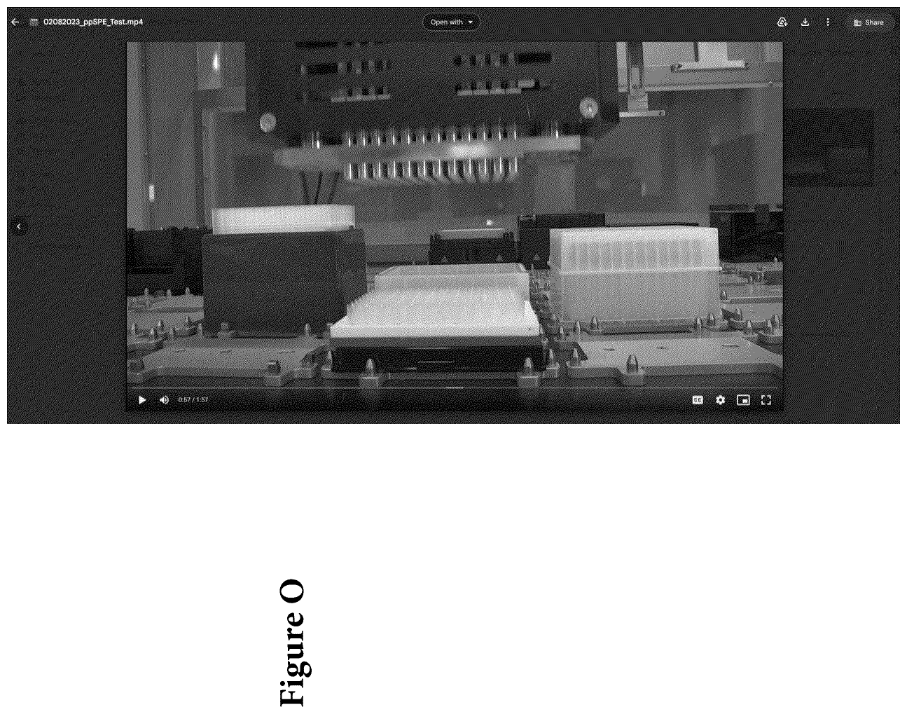

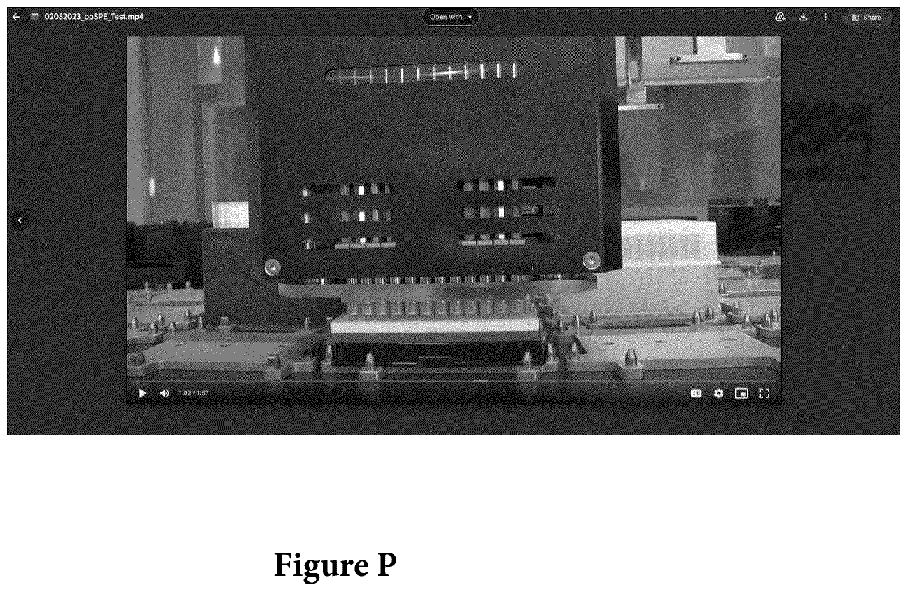

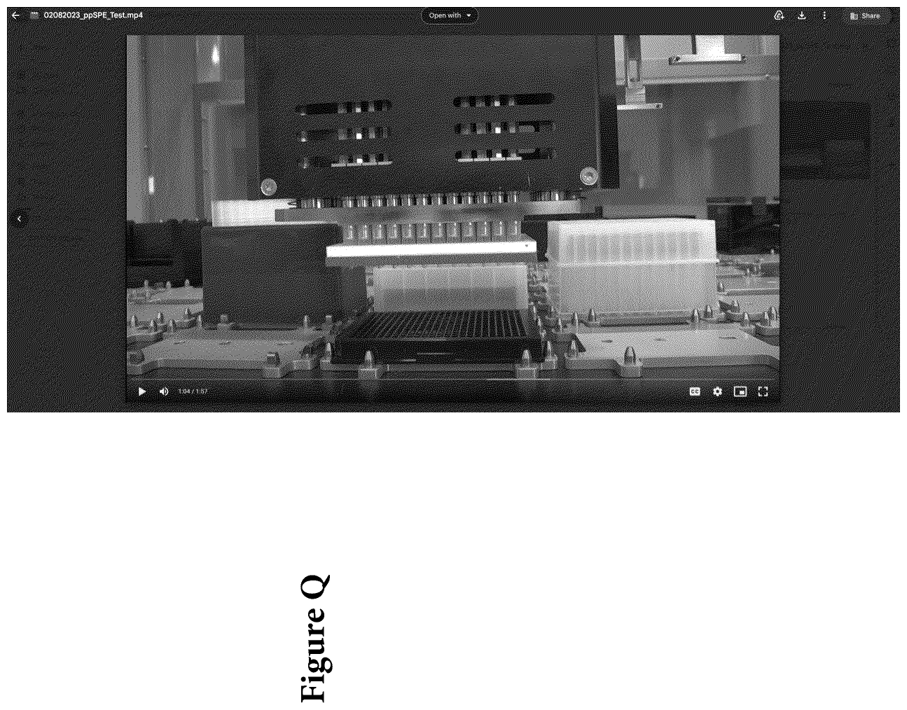

Turning now to FIG. 28 there is shown several views of one embodiment of an interchangeable bead washing tool head which may be mounted on a robotic arm of the invention. In the embodiment of FIG. 2, this bead washing tool head may be adapted to liquid handler head 2016. This bead washing tool head may also be adapted to the Lynx 900 Purification System manufactured by Dynamic Devices LLC of Wilmington Delaware.

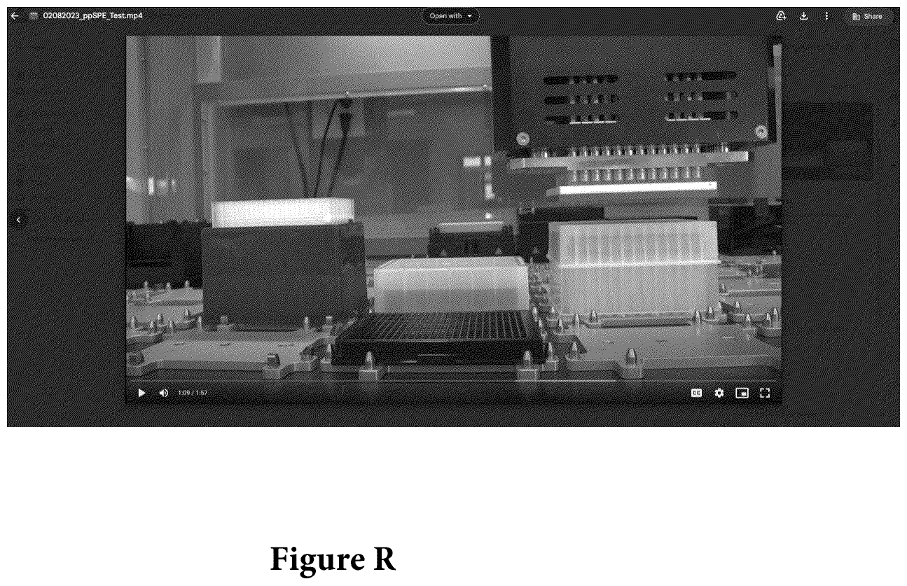

Turning now to FIG. 29 there are shown several views of one embodiment of an interchangeable positive pressure tool head which may be mounted on a robotic arm of the invention. In the embodiment of FIG. 2, this positive pressure tool head may be adapted to liquid handler head 2046. This positive pressure tool head may also be adapted to the Lynx 900 Purification System manufactured by Dynamic Devices LLC of Wilmington Delaware.

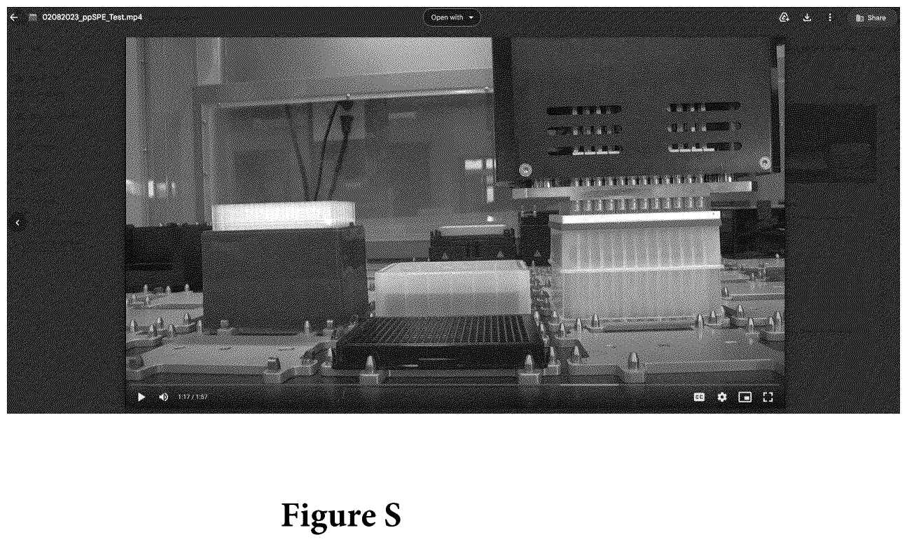

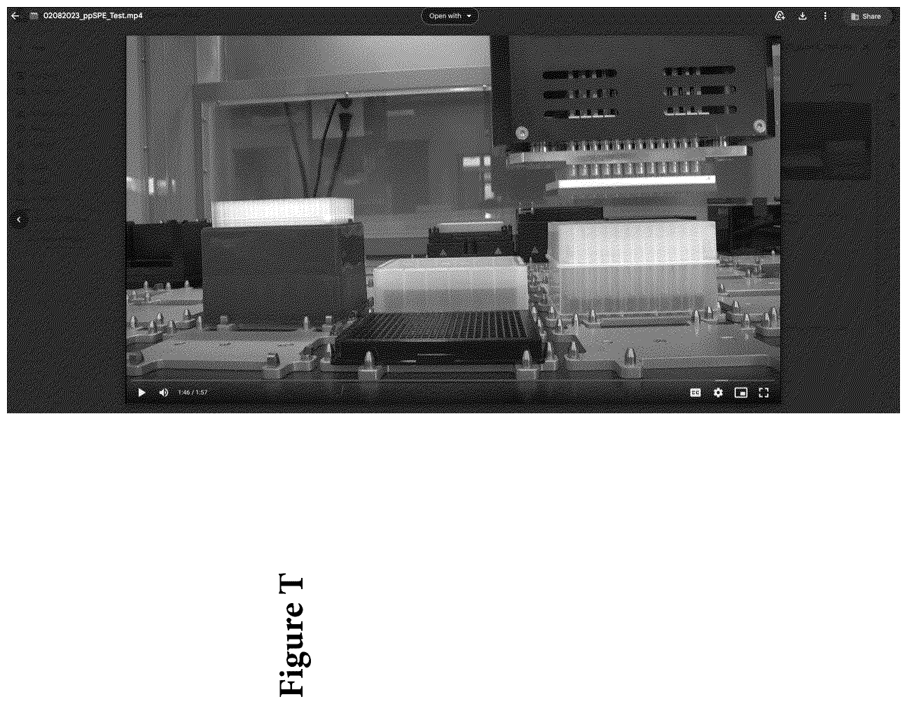

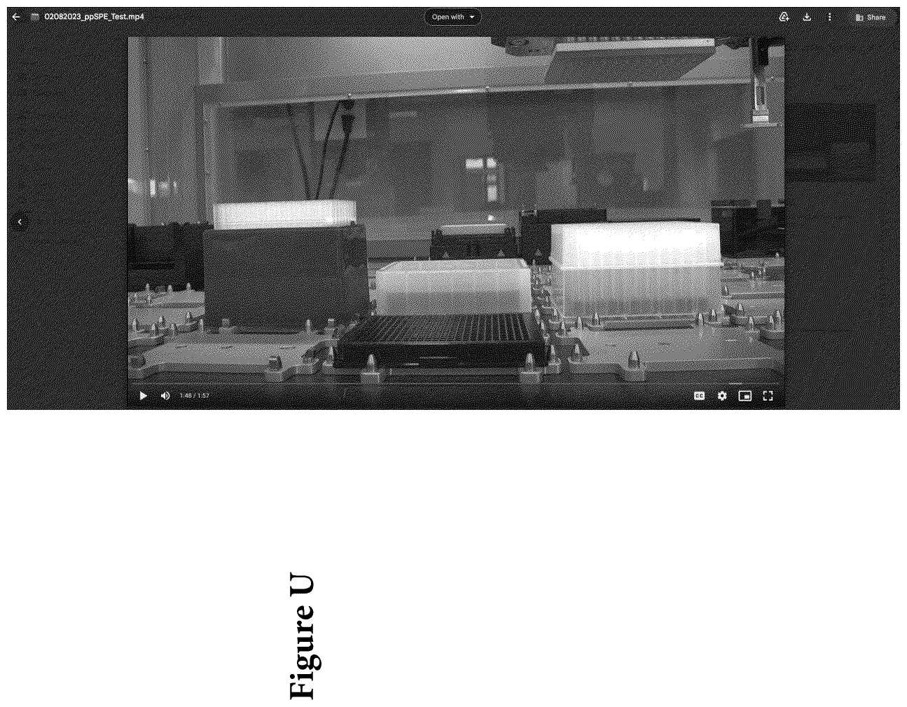

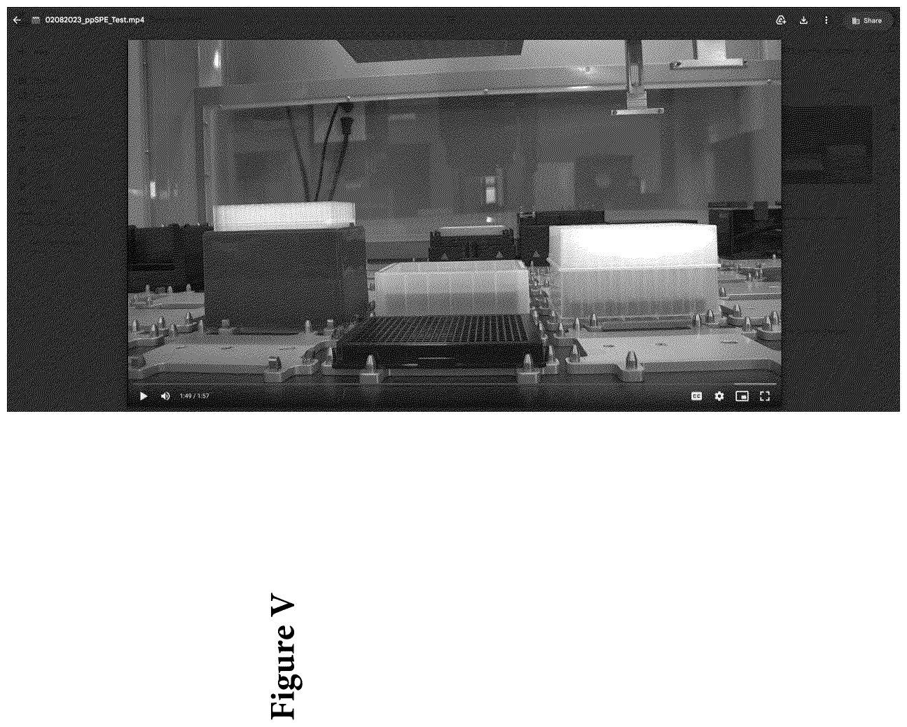

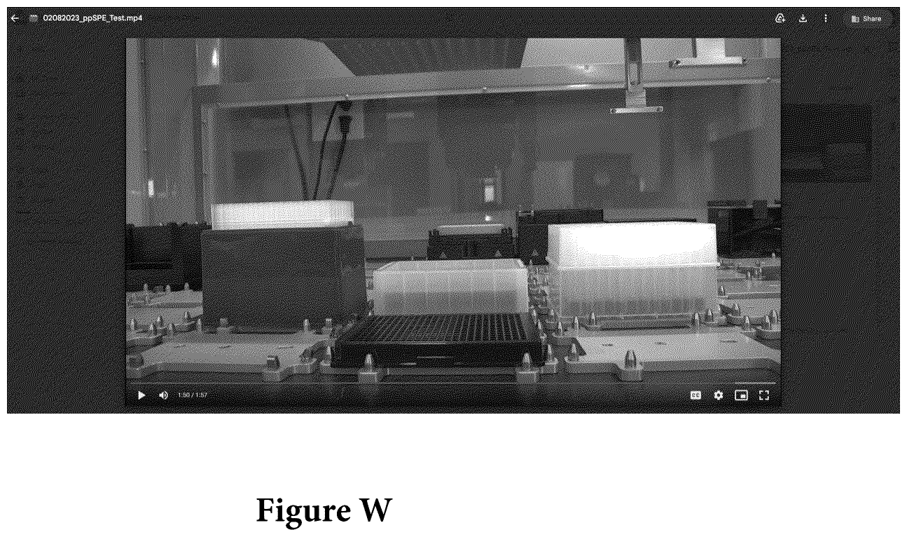

Turning now to FIGS. 30, 31, and 32, there are shown several views of one embodiment of the magnetic liquid handler system of this invention having a single robotic arm and which comprises the interchangeable heads of FIGS. 28 and 29. In this embodiment, the single robotic arm may automatically pick up and utilize sequentially either of the interchangeable heads of FIGS. 28 and 29. When the automatic processing utilizing one of the heads is completed, the robotic arm may automatically disengage from the first head being used and pick up and utilize the second head as required by the purification process being employed.

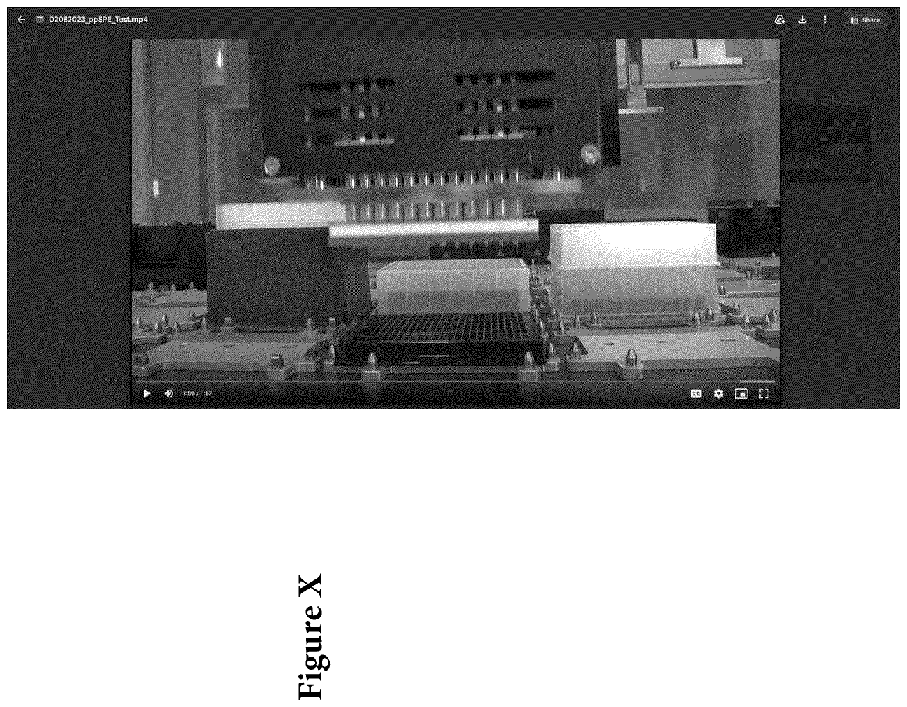

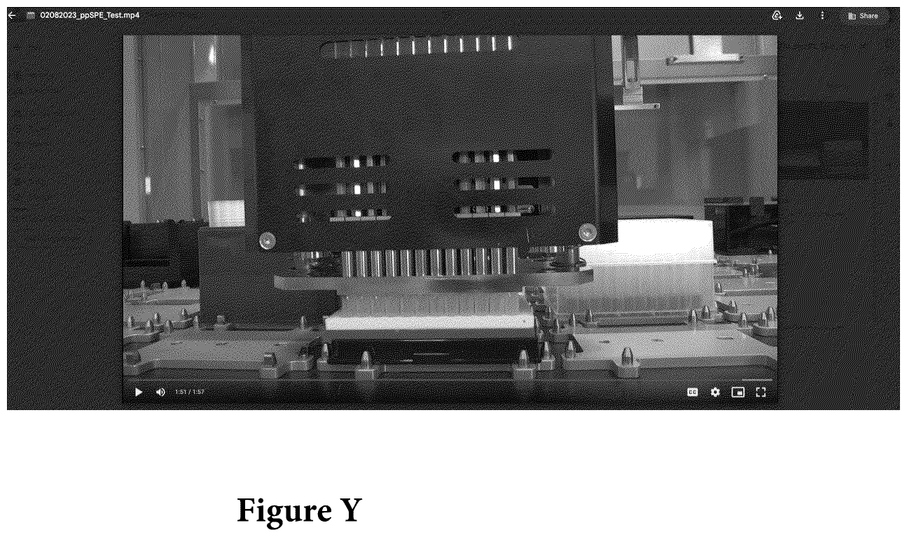

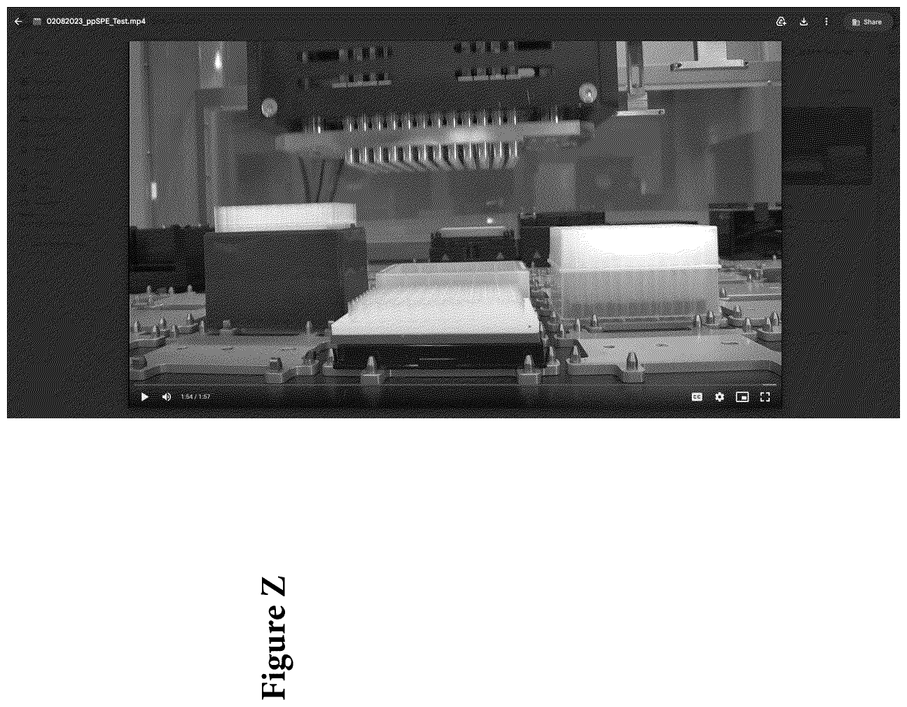

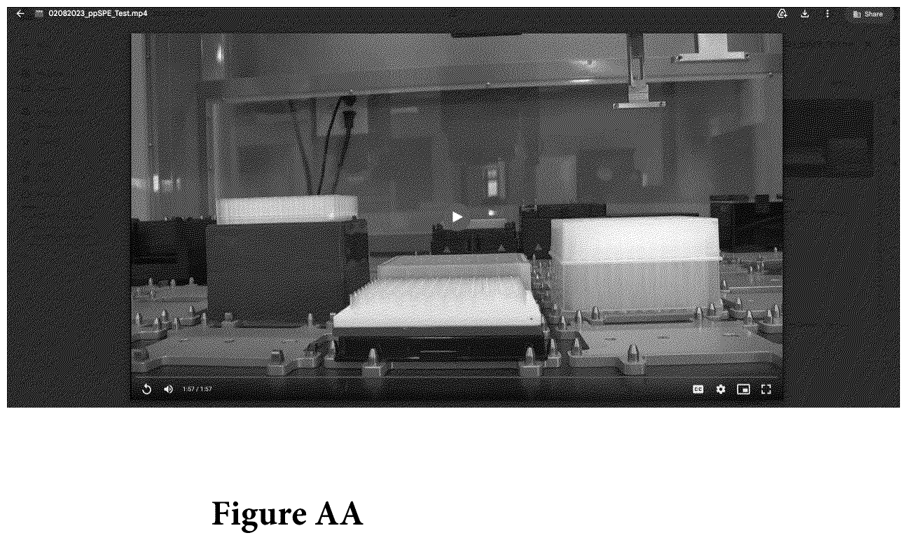

Turning now to FIGS. 33, 34, and 35, there are shown several views of one embodiment of the magnetic liquid handler system of this invention having dual robotic arms each of which may comprise the interchangeable heads of FIGS. 28 and 29. In this embodiment, the dual robotic arms may individually automatically pick up and utilize sequentially either of the interchangeable heads of FIGS. 28 and 29. When the automatic processing utilizing one of the heads is completed, the robotic arms may automatically disengage from the first head being used and pick up and utilize the second head as required by the purification process being employed,

The disclosure herein is directed to the variations and modifications of the elements and methods of the invention disclosed that will be apparent to those skilled in the art in light of the disclosure herein. Thus, it is intended that the present invention covers not only the embodiments which are disclosed herein but also all modifications and variations of those embodiments and all equivalents thereof.

1. An apparatus for handling, purifying, and otherwise processing engineered biologics molecules comprising:
liquid handler assembly;
one or more interchangeable tooling heads adapted to engage and disengage with said liquid handler assembly;
a positive pressure manifold and adapter adapted to engage with said liquid handler assembly;
a sample plate having a plurality of individual wells to store, process and transport the engineered biologics molecules samples being processed by said liquid handler assembly; and
a computerized control system which generates commands to said apparatus to sequentially execute the handling, purifying and otherwise processing said engineered biologics molecules.

2. The apparatus of claim 1, wherein said engineered biologics molecules are antibodies.

3. The apparatus of claim 1, wherein said liquid handler assembly comprises dual robotic arms adapted to engage and disengage said interchangeable tooling heads.

4. The apparatus of claim 1, wherein said liquid handler assembly comprises dual robotic arms adapted to engage and disengage said positive pressure manifold and adapter.

5. The apparatus of claim 1, wherein said liquid handler assembly comprises a single robotic arm adapted to engage and disengage said interchangeable tooling heads.

6. The apparatus of claim 1, wherein said liquid handler assembly comprises a single robotic arm adapted to engage and disengage said positive pressure manifold and adapter.

7. The apparatus of claim 1, wherein said apparatus processes said biologics molecules in less than about two minutes on average.

8. The apparatus of claim 1, wherein said sample plate comprises six wells per plate.

9. The apparatus of claim 1, wherein said sample plate comprises twenty-four wells per plate.

10. The apparatus of claim 1, wherein said sample plate comprises ninety-six wells per plate.

11. A positive pressure adapter comprising:
a support plate having openings therethrough, wherein said openings are capable of accommodating one or more pipette tips; and
a gasket adjacent to said support plate, said gasket having openings therethrough, wherein said openings are capable of accommodating one or more pipette tips.

12. The positive pressure adapter of claim 11, wherein said support plate comprises an ABS plastic.

13. The positive pressure adapter of claim 11, wherein said gasket comprises silicone.

14. The positive pressure adapter of claim 11, wherein said gasket is adhered to said support plate.

15. The positive pressure adapter of claim 11, further comprising an array of pipette tips inserted into said openings of said support plate and said gasket.

16. The positive pressure adapter of claim 11, further comprising a positive pressure manifold engaged with said positive pressure adapter to generate a positive pressure in a pipette tip inserted into said openings of said support plate and said gasket.
